(19) United States
(12) Patent Application Publication
(10) Pub. No.: US 2012/0061590 A1
(43) Pub. Date: Mar. 15, 2012

(54) SELECTIVE EXCITATION LIGHT FLUORESCENCE IMAGING METHODS AND APPARATUS

(75) Inventors: Mehrnoush Khojasteh, Burnaby (CA); Calum Eric Macaulay, Vancouver (CA)

(73) Assignee: British Columbia Cancer Agency Branch, Vancouver, BC (CA)

(21) Appl. No.: 13/321,818

(22) PCT Filed: May 21, 2010
(86) PCT No.: PCT/CA2010/000759

§ 371 Date: Nov. 21, 2011

Related U.S. Application Data
(60) Provisional application No. 61/180,769, filed on May 22, 2009.

(51) Int. Cl. G01N 21/64; G01N 21/25

(52) U.S. Cl. 250/459.1; 356/405; 250/458.1; 250/208.1

(57) ABSTRACT

Imaging methods and apparatus may be applied to image tissues as well as other areas. A computer-controlled color-selectable light source is controlled to emit light having a desired spectral profile and to illuminate an area. An imaging detector images the illuminated area. The spectral profile may be selected to yield images in which contrast between features of interest and other features is enhanced. The images may be combined into a composite image. In some embodiments the spectral profile is based on a principal components analysis such that the images each correspond to one principal component.

### CROSS-REFERENCE TO RELATED APPLICATION

This application claims convention priority from U.S. application No. 61/180,769 filed 22 May 2009 and entitled SELECTIVE EXCITATION LIGHT FLUORESCENCE IMAGING, which is hereby incorporated herein by reference. For the purpose of the United States of America, this application claims the benefit under 35 U.S.C. §119 of U.S. application No. 61/180,769 filed 22 May 2009 and entitled SELECTIVE EXCITATION LIGHT FLUORESCENCE IMAGING, which is hereby incorporated herein by reference.

### TECHNICAL FIELD

The invention relates to imaging and has particular, although not exclusive, application to medical imaging. Embodiments of the invention provide methods and apparatus that have application in screening for cancer and other medical conditions as well as monitoring treatments.

### BACKGROUND

Recognizing medical conditions is the first step towards their treatment. For example, early detection is one key to achieving successful outcomes in cancer treatment. There is a need for screening tests that facilitate detection of cancerous or pre-cancerous lesions.

Fluorescence imaging has been used to view and image tissues. Conventional fluorescence imaging typically involves illuminating a tissue with light that can excite fluorophores in tissues to emit light at one or more fluorescent wavelengths different from the illumination wavelength and detecting the fluorescent light. Fluorescence imaging is applied in techniques such as: autofluorescence bronchoscopy; autofluorescence colposcopy; direct fluorescence oral screening; fluorescence microscopy and the like.

Techniques for fluorescent imaging of tissues include fluorescence in-situ hybridization FISH imaging; and immunohistochemistry IHC imaging. In most cases, FISH and IHC images are evaluated in a semi-quantitative fashion by skilled human observers. While these processes can be partly automated the analysis of FISH and IHC results remains time-consuming and prone to errors.

Panasyuk et al. WO 2006058306 describes a medical hyperspectral imaging technique. Barnes et al. WO/2009/154765 describes a medical hyperspectral imaging technique. Zuzak et al. United States Patent Application 2010/0056928 discloses a digital light processing hyperspectral imaging apparatus. Mooradian et al. U.S. Pat. No. 5,782,770 discloses hyperspectral imaging methods for non-invasive diagnosis of tissue for cancer. U.S. Pat. Nos. 6,608,931, 6,741,740, 7,567,712, 7,221,798, 7,085,416, 7,321,691 relate to methods for selecting representative endmember components from spectral data.

There remains a need for methods and apparatus capable of use in screening for cancerous lesions, pre-cancerous lesions and/or other features of medical interest that produce diagnostically useful results, are cost-effective, and are practical to apply.

### SUMMARY OF THE INVENTION

The invention has a number of aspects. One aspect provides methods for imaging tissues. The methods may be applied in vivo and ex vivo. The methods optionally apply image analysis to flag potential lesions or other features of interest. For example, the methods may be applied to the imaging of different tissue structures, organs, or responses of tissue to injury or infection or treatment.

Another aspect of the invention provides apparatus for imaging tissues. In some embodiments the apparatus is configured to screen for specific conditions.

One aspect provides tissue imaging method comprising obtaining a plurality of images by performing at least two iterations of: providing a set of weights containing a weight for each of a plurality of spectral bands and controlling a computer-controlled color-selectable light source to illuminate a tissue with light in a first wavelength window, the light having a spectral composition according to the weights; and operating an imaging detector to obtain at least one image of the tissue in one or more second wavelength window outside of the first wavelength window and including the at least one image in the plurality of images. The method combines the plurality of images into a composite image and displays the composite image. The set of weights is different in different iterations.

Another aspect provides imaging apparatus. The imaging apparatus comprises a computer-controlled color-selective light source; an imaging detector located to image an area being illuminated by the computer-controlled light source; a display; and a controller. The controller comprises a plurality of predetermined sets of weights, Each set of weights comprises a weight for each of a plurality of spectral bands. The controller is configured to control the light source and the imaging detector to obtain a plurality of images. The controller causes the apparatus to perform at least two iterations of: providing one of the sets of weights to the light source and controlling the light source to illuminate the area with light in a first wavelength window, the light having a spectral composition according to the weights; operating the imaging detector to obtain at least one image of the area in one or more second wavelength windows outside of the first wavelength window; and including the at least one image in the plurality of images. The controller combines the plurality of images into a composite image and displays the composite image on the display.

Further aspects of the invention and features of specific embodiments of the invention are described below.

### BRIEF DESCRIPTION OF THE DRAWINGS

The accompanying drawings illustrate non-limiting example embodiments of the invention.

FIG. 1 is a block diagram of apparatus according to an example embodiment of the invention.

FIG. 2 is a flow chart which illustrates a method for preparing multispectral images according to one embodiment.

FIGS. 3A to 3H are reproduction of micro images that illustrate segmentation of image data for a lung biopsy tissue section.

FIG. 4 shows spectra used to obtain narrow-band exposures of a scene.

FIGS. 4A through 4C show spectra used to obtain principal component images in single exposures for the scene.

FIG. 5 is a flow chart which illustrates a method for efficiently acquiring multispectral images according to another embodiment.

FIGS. 5A and 5B are data flow diagrams according to an example embodiment.

FIGS. 6A through 6F illustrate excitation emission matrices for different fluorophores.

FIGS. 7A and 7B illustrate schematically a microscopy apparatus according to an example embodiment and endoscopy apparatus according to another example embodiment. FIG. 7C illustrates schematically a treatment apparatus incorporating an imaging system. FIG. 7D illustrates an image that might be produced by the apparatus of FIG. 7C.

FIGS. 8A through 8K are sample images that illustrate an example application of methods described herein in vivo.

FIGS. 9A through 9O are sample images that illustrate an example application of methods described herein ex vivo.

FIG. 10 illustrates data flow in an embodiment wherein differences in photo-bleaching are exploited.

### DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

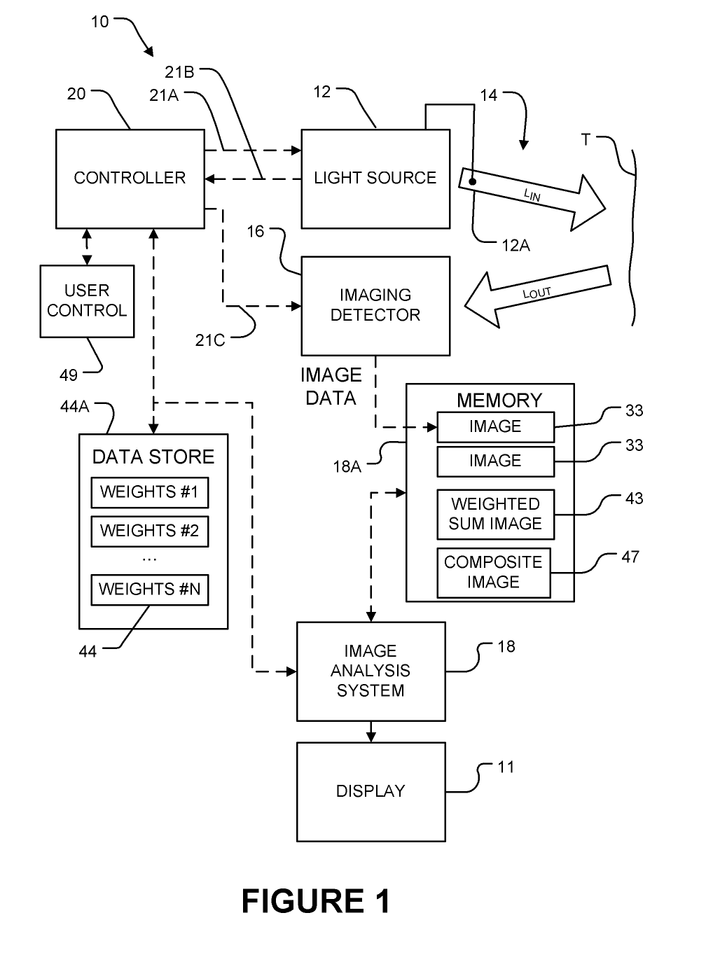

FIG. 1 shows an imaging apparatus 10 according to an embodiment of the invention. Apparatus 10 comprises a wavelength-selectable light source 12. Light L_{IN} from light source 12 is directed to be incident on a tissue T of interest by way of an optical path 14. Light L_{OUT} arising from the tissue of interest is detected by an imaging detector 16. Images captured by detector 16 are provided to an analysis system 18 for analysis.

Light source 12 comprises a color-programmable light source such that the spectrum of light emitted as L_{IN} can be controlled. In an example embodiment, light source 12 emits light in the visible part of the spectrum (390 to 750 nm). On other embodiments light source 12 emits light in the spectral range between near infrared and near ultraviolet. In a prototype embodiment, light source 12 comprises a ONELIGHT SPECTRA™ light source available from Onelight Corp. of Vancouver, Canada.

Imaging detector 16 comprises an imaging detector capable of detecting wavelengths in L_{OUT}. In some embodiments, detector 16 comprises a monochrome detector. In some embodiments detector 16 comprises a CCD, or CMOS or APS imaging array. In some embodiments detector 16 comprises a camera such as a color CCD camera. In some embodiments, imaging detector 16 comprises a scanning detector that scans an area of interest to guide light to a point, line or small-area array. Imaging detector 16 may comprise a filter or wavelength separator (such as a grating, prism, or the like) that excludes or substantially attenuates wavelengths corresponding to L_{IN}.

A control system 20 coordinates the operation of light source 12 and detector 16. Many modes of operation are possible. Control system 20 is connected to turn light source 12 on and off and to control the spectrum (intensity as a function of wavelength) of light emitted by light source 12 by a control path 21A and to receive information from light source 12 by a data path 21B. Control system 20 is connected to trigger the acquisition of images by imaging detector 16 by way of a control path 21C. Control system 20 comprises analysis system 18. Control system 20 and analysis system 18 may be integrated or separate from one another. For example, in some embodiments, control system 20 comprises a programmed computer and image analysis system 18 comprises software instructions to be executed by the programmed computer for performing analysis of images captured by imaging detector 16.

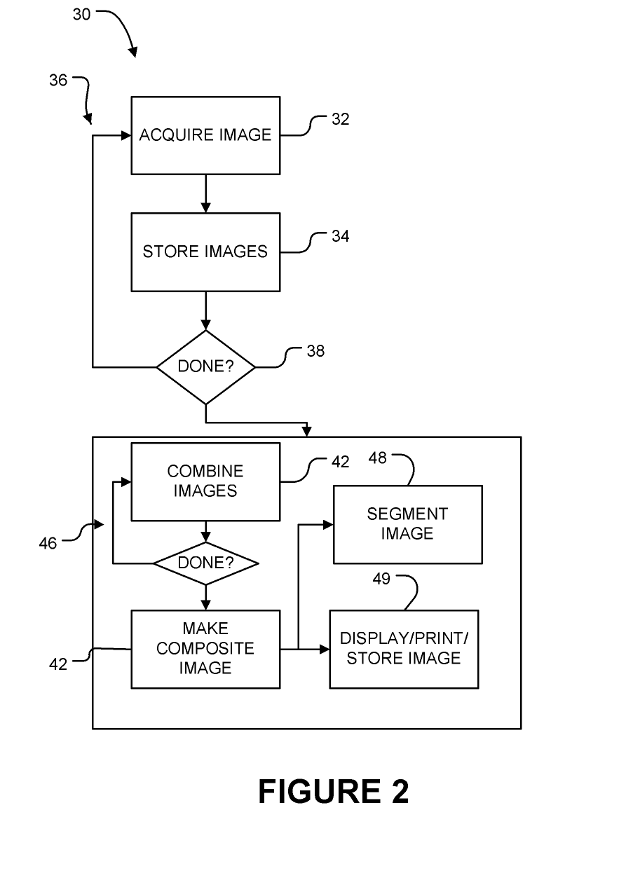

FIG. 2 illustrates a method 30 coordinated by controller 20 in one example mode. In block 32, method 30 controls light source 12 to emit light in a narrow wavelength band at an intensity and for a period of time sufficient to allow imaging detector 16 to capture an image. In block 32 method 30 triggers detector 16 to acquire an image 33. In block 34, image 33 is stored in a memory 18A accessible to analysis system 18. Controller 20 causes loop 36 to be repeated a number of times for different wavelength bands of light L_{IN}. When block 38 determines that the desired number of images 33 have been acquired, control system 20 triggers image analysis system 18 to analyze the acquired images 33. All images 33 image the same tissue.

Any suitable number of images 33 may be acquired. In an example embodiment, images 33 are obtained for each of a plurality of narrow bands of illumination L_{IN} spaced apart in a first wavelength window. For example, in one embodiment the wavelength window is 400 nm to 530 nm. The narrow bands may be centered at wavelengths separated by 10 nm, for example.

Images 33 may exclude wavelengths present in L_{IN}. In some embodiments, images 16 may be based on L_{OUT} in a second wavelength window outside of the first wavelength window of L_{IN}. The second wavelength window may comprise longer wavelengths than are present in the first wavelength window. In the above example, the second wavelength window may comprise wavelengths in the range of about 550 nm to about 700 nm for example.

Analysis system 18 performs analysis of the acquired images 33 in block 40. Analysis comprises combining a plurality of images 33 to yield a single output image. In some embodiments the output image is a false color image. In the illustrated embodiment combining is performed in block 42 and comprises determining a weighted sum image 43 by taking a weighted sum of pixel values from some or all of images 33. For example, each pixel in weighted sum image 43 may have a value given by:

$$P ( x , y ) = {\sum }_{i} {W}_{i} {P}_{i} ( x , y ) \qquad ( 1 )$$

where: P(x,y) is the value for the pixel at location x,y in weighted sum image 43; i is an index identifying individual ones of images 33; Wᵢ is a weight 44 corresponding to the ith image 33; and Pᵢ(x,y) is the value of the pixel at location x,y in the ith one of images 33.

In some embodiments a light sensor 12A is provided to measure the intensity of light emitted by light source 12. Light sensor 12A may, for example, be integrated into light source 12. In some embodiments the weight applied to each image 33 in block 42 is additionally based in part on intensity information from sensor 12A and/or other exposure information from detector 16.

In some embodiments a plurality of weighted sum images 43 are determined as indicated by loop 45. The weights 44 may be different for each of the plurality of weighted sum images 43. The plurality of weighted sum images may then be combined into a composite image 47 in block 46. In some embodiments, composite image 47 comprises a false color image. In such embodiments, each of the weighted sum images 43 may be rendered in a corresponding color. For example, a composite 47 may have a red channel, a blue channel and a green channel. Each channel may comprise a weighted sum image 43 corresponding to the channel.

In other embodiments, weighted sum images may be combined mathematically with one another and/or with images 33 to yield a composite image 47, for example by adding, subtracting, or performing other mathematical operations.

In some embodiments, weights 44 are weights that have been determined by principal component analysis (PCA) on a set of images 33. Principal component analysis is described, for example, in I. T. Joliffe Principal Component Analysis, Springer 2002 ISBN 0-387-95442-2 which is hereby incorporated herein by reference. In an example embodiment, weights 44 correspond to a first principal component.

In embodiments where multiple weighted sum images 43 are provided, weights 44 for each of the images 43 may correspond to one highest-ranking principal component. For example, images 33 may be processed by principal component analysis to identify a plurality of principal components. The N highest-ranking (e.g. first, second etc.) principal components may be used as images 43. N may be 3 in some embodiments. For example, the three highest-ranking principal components may be obtained and each assigned to a primary color to yield a false color composite image.

In some embodiments weights 44 are selected to emphasize certain tissue features while de-emphasizing other tissue features. For example, contrast between the certain tissue features of interest and other tissue features may be increased. For example, sets of weights 44 may be selected to emphasize a certain tissue type or cell type. In some embodiments, apparatus 10 provides multiple different predetermined sets of weights 44 each selected to emphasize certain features of tissue T. Apparatus 10 may be configured to allow a user to select a desired set of weights 44 and to generate and display an image using the selected set of weights 44. Apparatus 10 may comprise a plurality of predetermined sets 44A of weights 44.

Apparatus 10 comprises a user control 49 which is monitored by control system 20. Control system 20 selects a set 44A of weights to be applied in response to user input received by way of control 49. Control 49 may comprise any suitable user interface technology (switch, touch screen, graphical user interface, knob, selector, wireless receiver, etc.). In some embodiments, control 49 permits a user to rapidly switch among different sets of weights as images are acquired.

It is not mandatory that all weights 44 be positive. Some weights 44 could be negative in this embodiment.

The weighted sum image(s) 43 and/or composite image 47 may be displayed on a display 11 for review by a person, stored in a computer-accessible data store for future processing, records purposes, or the like or printed. The weighted sum image(s) 43 and/or composite image 47 may highlight features of the tissue T. Some examples of features that may be highlighted include:
areas having different amounts of vascularity;
areas that have received or not received a treatment or areas that have responded to or not responded to a treatment;
concentrations of one or more tissue components such as collagen, elastinen, and the like;
relative amounts of collagen and elastinen present in imaged tissues;
different tissue types;
different cell types;
neoplastic tissue;
blood absorption;
areas where tissue is inflamed;
NADH (nicotinamide adenine dinucleotide) concentration;
FAD (flavin adenine dinucleotide) concentration;
porphyrin concentration;
or the like.

In some embodiments, analysis system 18 is configured to perform segmentation on a weighted sum image 43 and/or a composite image 47. In the illustrated embodiment, segmentation is performed in block 48. Advantageously, the weighted sum image 43 and/or composite image 47 may have improved contrast as compared to a standard image such that an automated segmentation algorithm can identify structures such as cells, nuclei, boundaries between tissue types or the like with enhanced accuracy.

As another example application, a training set may be created by manually classifying features shown in images of tissue. For example, manual classification may identify in an image pixels that correspond to each of positive cell nuclei, negative cell nuclei and background. Stepwise Linear Discriminant Analysis (LDA) may then be applied to images 33 to derive first and second sets of weights (discriminant functions) for each of two linearly combined images that best separate the three classes of pixels in the training set. The first and second sets of weights may then be applied to obtain weighted sum images 43 of other tissues. In each case, two images 43 are obtained, a first image 43 corresponding to the first set of weights and a second image 43 corresponding to the second set of weights. In the first image 43 the positive nuclei may be highlighted relative to the background whereas, in the second image 43 the negative nuclei may be highlighted against the background.

Each image 43 may then be automatically thresholded and nuclei may be segmented. using a suitable segmentation methodology. Various segmentation algorithms are described in the literature. The increased contrast of images 43 facilitates segmentation.

Images 43 are displayed, printed and/or stored in block 49.

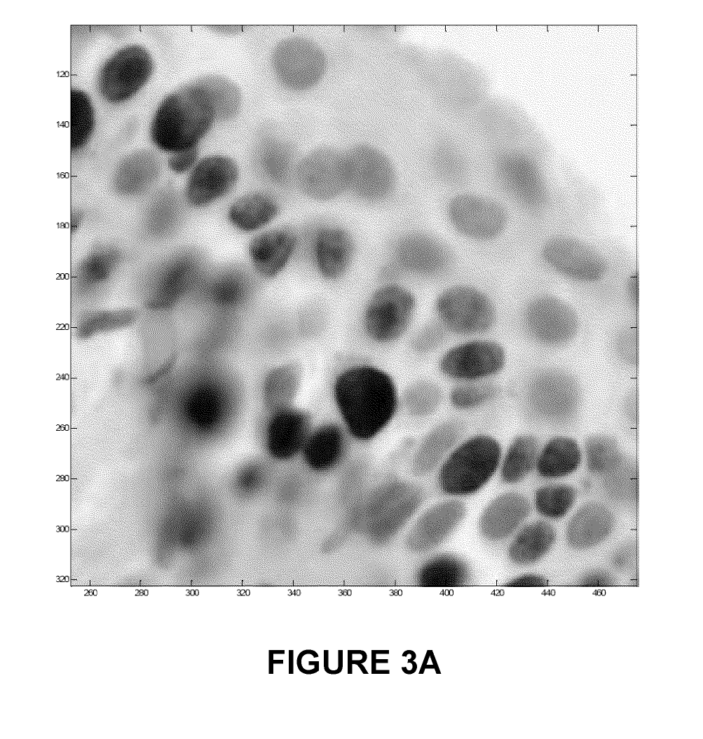

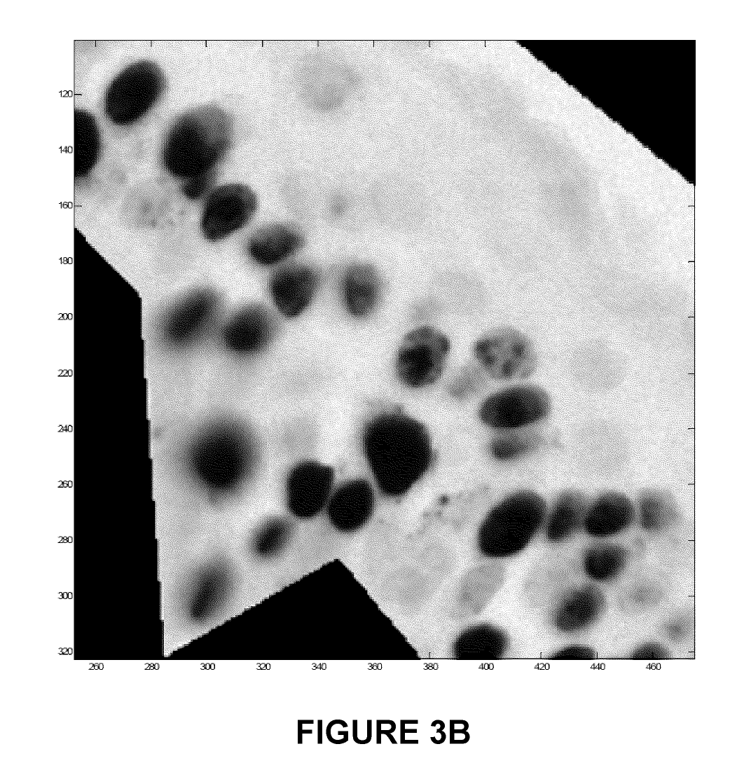

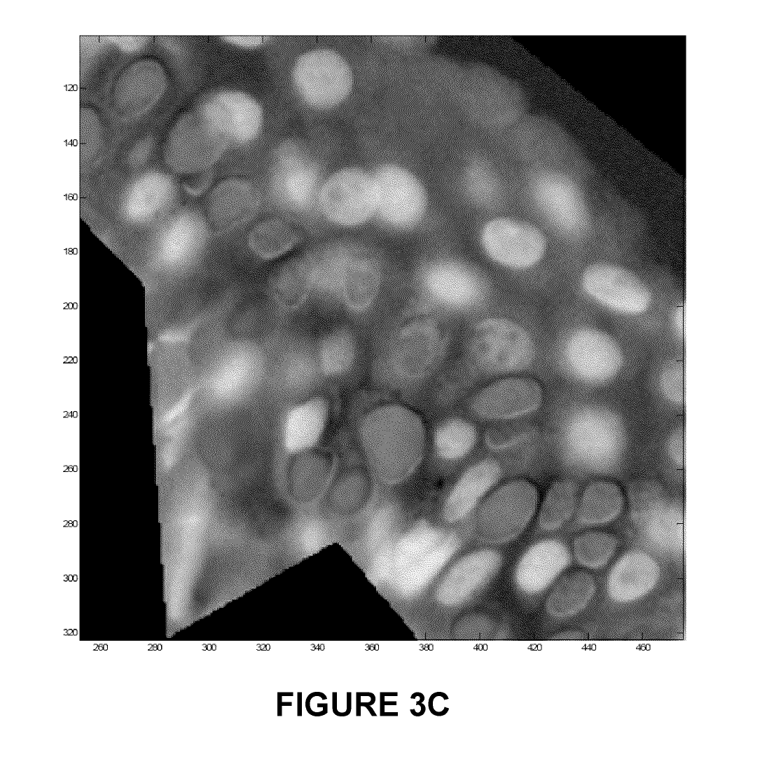

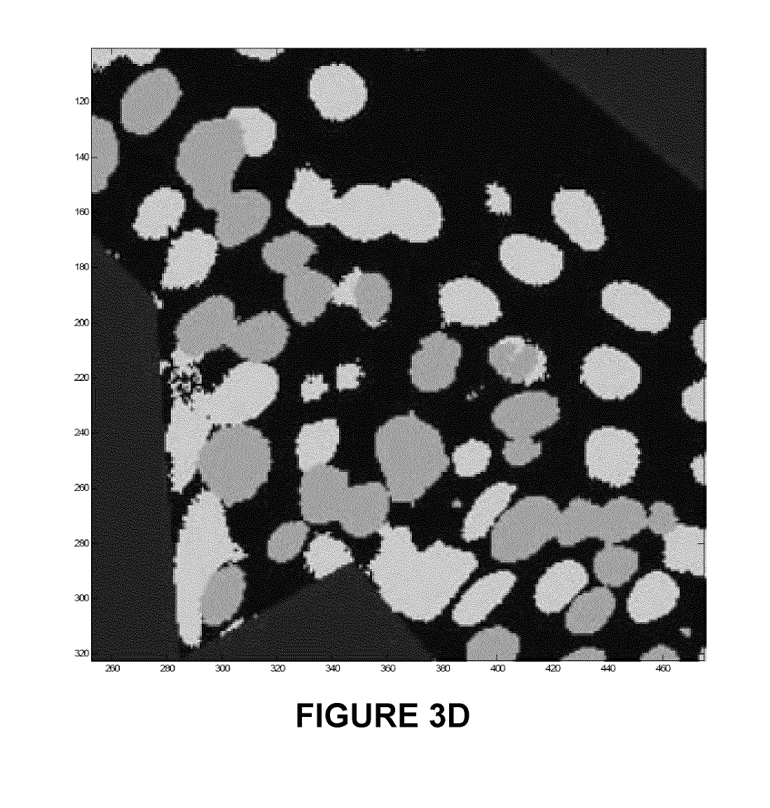

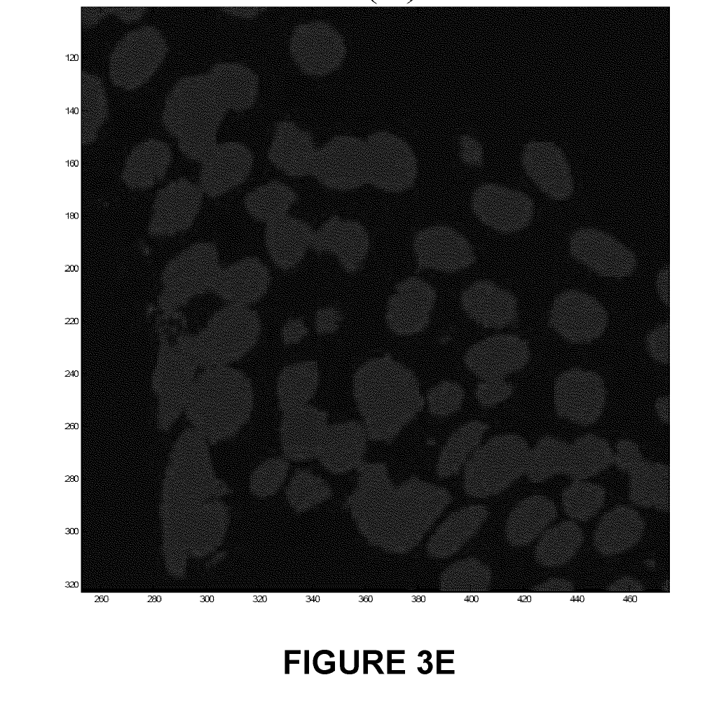

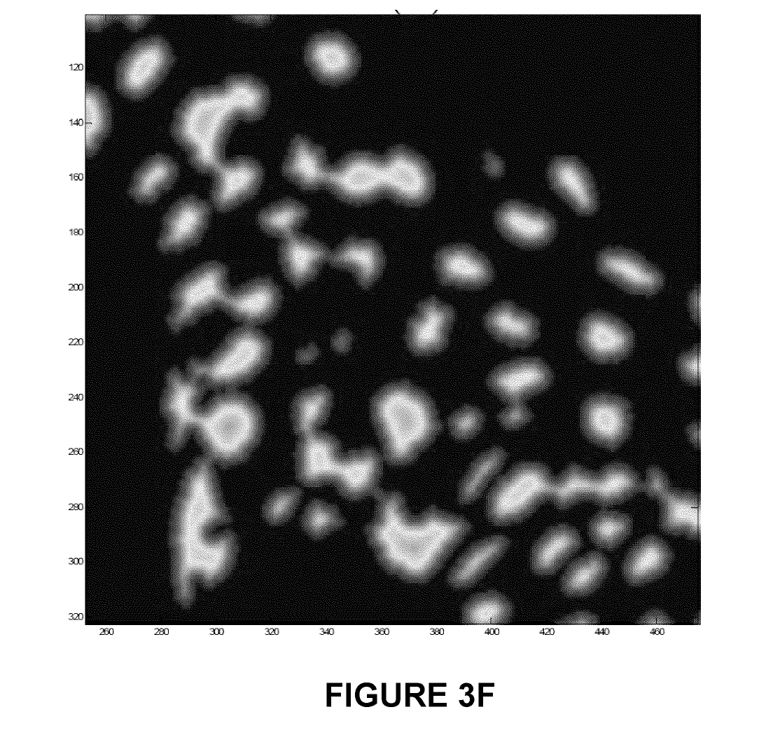

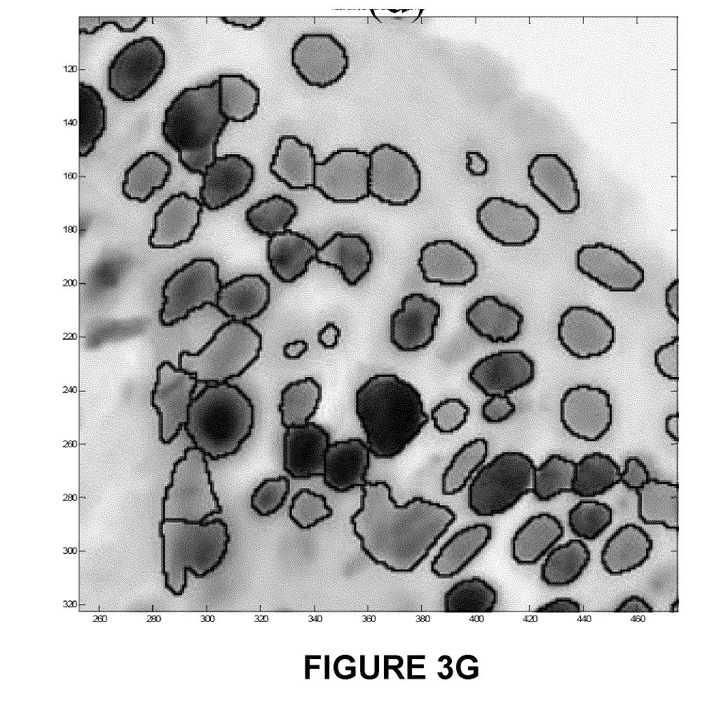

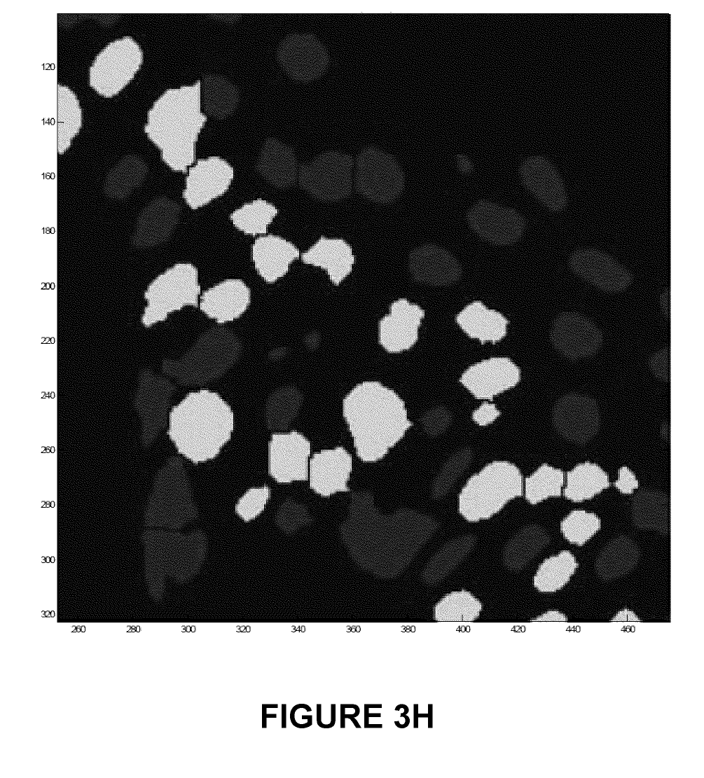

FIGS. 3A to 3H illustrate segmentation of an image of a lung biopsy tissue section stained by DAB and Haematoxylin. A training set was generated by manually selecting regions on the similarly stained images corresponding to the three classes of positive nuclei pixels, negative nuclei pixels and background. Stepwise linear discriminant analysis was used to calculate two linearly combined images that best separated the three classes of pixels in the training set. The discriminant functions obtained from the training set were then applied to the image stack of interest. FIG. 3A is a greyscale representation of an RGB image of a region of interest. FIG. 3B shows a weighted sum image in which weights are chosen to increase the contrast between positive nuclei pixels and other pixels. FIG. 3C shows a weighted sum image in which weights are chosen to increase the contrast between negative nuclei and background. FIG. 3D shows pixel classification results. FIG. 3E shows a binary mask of objects identified in the image. FIG. 3F shows application of a distance transform. FIG. 3G shows borders identified after watershed segmentation. FIG. 3H shows a resulting image in which positive and negative nuclei have been separated.

In some embodiments features of interest are detected by comparison of two or more images. The comparison may be achieved by displaying the images on a display in alternation or creating a composite image by subtracting the images from one another, for example.

In some embodiments, imaging detector 16 is not wavelength specific. In other embodiments, imaging detector 16 is wavelength specific (i.e. imaging is performed in a manner that can discriminate between different emission wavelengths and/or emission spectra). In some such embodiments separate images or image components are obtained for a plurality of emission wavelength spectra. For example, imaging detector 16 may comprise one or more color cameras and/or one or more monochrome cameras. In some embodiments, imaging detector 16 comprises a plurality of imaging detectors that operate to detect light in different wavelength bands. Any camera or other detector of imaging detector 16 may comprise one or more static or dynamic filters. In some embodiments wherein imaging detector 16 is wavelength specific, multiple images 33 are obtained for each wavelength band used for L_{IN} or for each spectrum presented as L_{IN}.

A very significant improvement in speed and quality can be achieved by acquiring composite images 43 in a single exposure (or a reduced number of exposures that includes fewer exposures than there are wavelength bands). This may be achieved, for example, by setting light source 12 to illuminate tissue T with a spectrum containing light in multiple wavelength bands. The intensity of light in each of the wavelength bands may be weighted according to weights 44 so that a single image acquired by imaging detector 16 corresponds to a desired weighted sum image 43. Generating the light may comprise setting a computer-controlled color-selectable light source, as described above, to illuminate tissue T with the desired, appropriately weighted, spectrum. In cases where N distinct weighted sum images 43 are desired then the N distinct weighted sum images 43 may be acquired using N exposures of imaging detector 16.

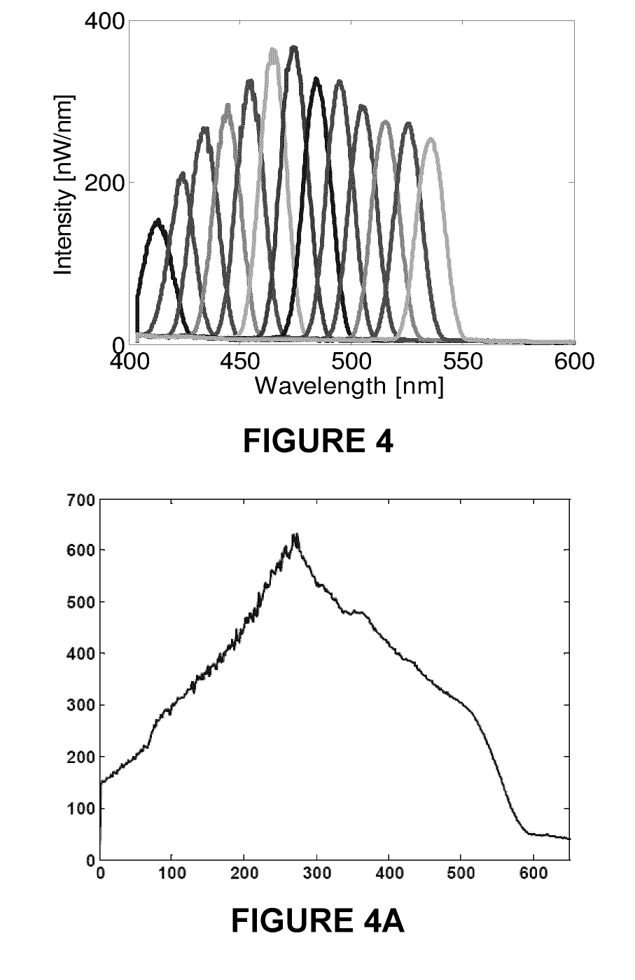

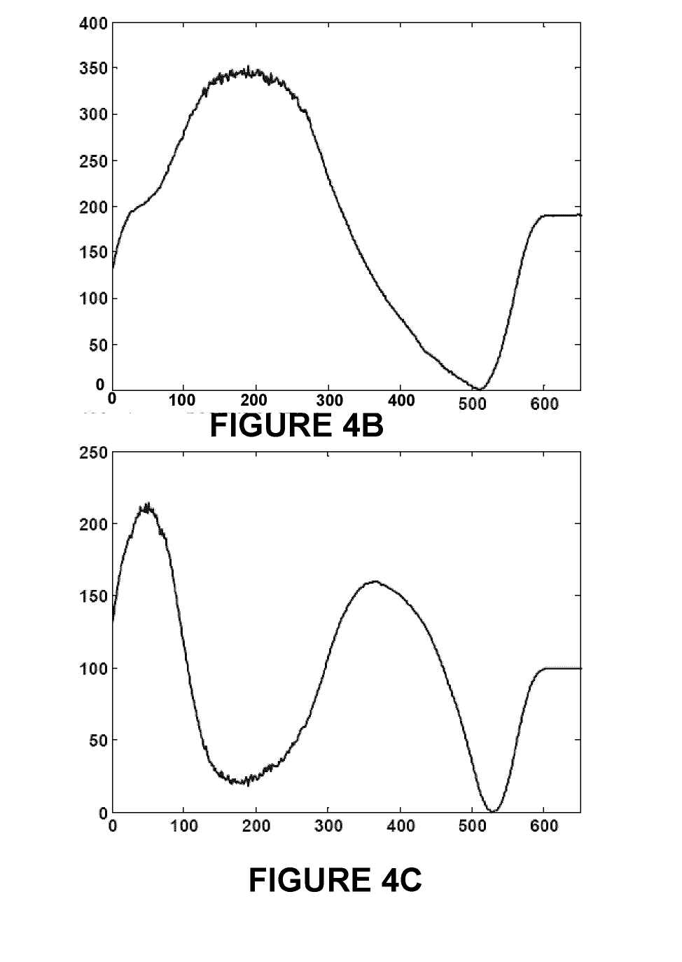

Experiments have been performed to establish that single images obtained by creating an illumination spectrum in which wavelength bands have selected weights can be closely similar to images obtained by making a weighted combination of multiple narrow-band images. In one such experiment 13 images of a scene were acquired. For each image the scene was illuminated with a different wavelength of narrow-band light between about 420 and 540 nm. The wavelength bands were separated by about 10 nm. The wavelength bands are illustrated in FIG. 4. The acquired images were subjected to PCA. Sets of weights for first, second and third principal component images were obtained. The principal component images were each obtained by weighting the narrow band images to weights of the corresponding set of weights and summing the weighted images.

Spectra for acquiring principal component images were calculated from the weights and the narrowband spectra. Spectra calculated for the first, second and third principal component images are shown in FIGS. 4A through 4C respectively. A color selectable light source was controlled to illuminate the scene and images were acquired using the spectra corresponding to each of the principal components. These images were compared to and were found to be very similar to the principal component images obtained by weighting and summing the narrow band images.

Different weighted sets of excitation wavelength illumination may be selected to enable the image detection of separate components (e.g. tissue types, cell types, etc). In one embodiment, different weighted images may be combined into one pseudo colour image. Different pseudo images may be created to represent different features present in the area imaged. For example, each pseudo image may represent a different fluorescent component (fluorophor) in the area imaged.

In addition to allowing image data to be obtained in a shorter time frame and avoiding problems caused by tissue movement and mis-registration of multiple images, Illuminating an area with multiple wavelengths simultaneously can advantageously couple more effectively to specific targeted fluorophor(s) than illuminating with narrow wavelength bands one by one.

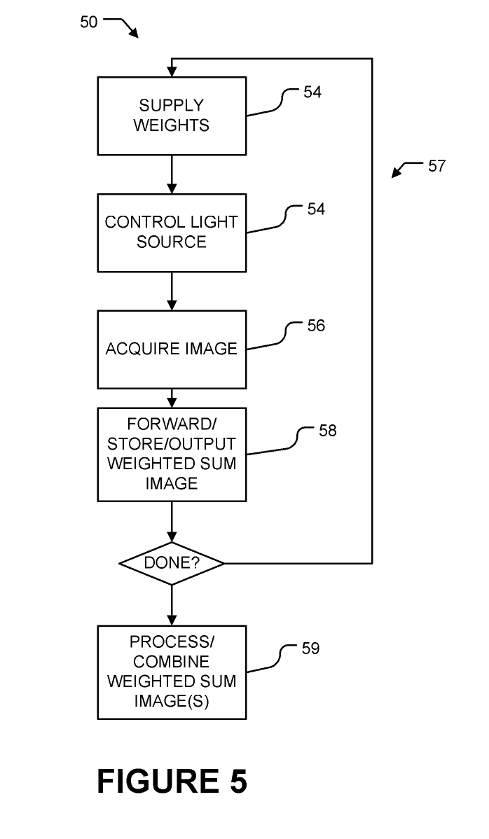

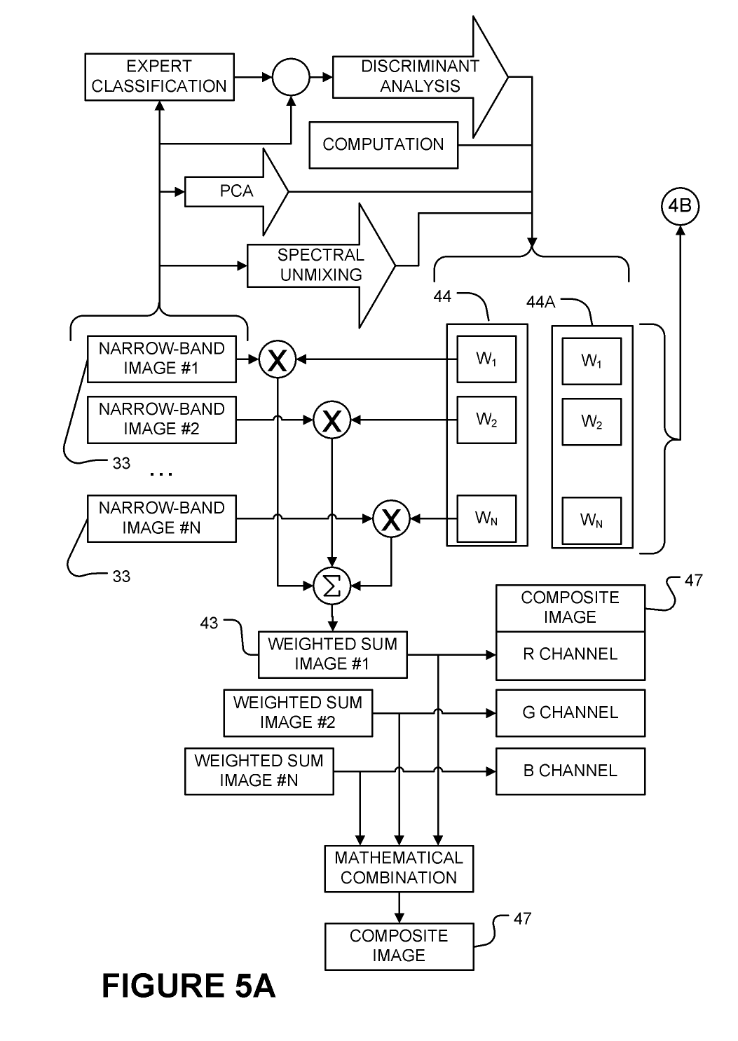

FIG. 5 illustrates a method 50 according to an embodiment in which weighted sum images are obtained in single exposures of imaging device 16. In block 52 weights 44 are supplied to light source 12. In block 54 light source 12 is controlled to emit light in which the intensity in each wavelength band is determined by the corresponding weight 44. Preferably light source 12 provides control over light in adjacent bands having a bandwidth (at FWHM) of 25 nm or less. The bandwidth may be, for example, 20 nm, 10 nm, 5 nm or less. In block 56, imaging detector 16 is triggered to acquire an image 43 of the tissue T. As indicated by loop 57, where multiple weighted sum images 43 are desired then blocks 52 through 56 may be repeated for each weighted sum image 43. In some embodiments, 3 weighted sum images are obtained.

The weighted sum images are stored, printed and/or displayed in block 58 and forwarded for further processing in block 59.

The weights 44 used to obtain weighted sum images 43 in methods like methods 30 and 50 may comprise weights derived in any of various ways. In some embodiments weights 44 are determined by PCA (e.g. may be components of a PCA eigenvector). For example, suitable weights 44 may be determined by obtaining images 33 as described above, performing PCA on the images 33, identifying a desired principal component (e.g. first, second third etc. principal component) and selecting as weights 44 the weights corresponding to the selected principal component.

In some embodiments, weights 44 are established by performing PCA on images 33 for tissue of a type that is of interest. The weights 44 are then stored and subsequently applied.

In some embodiments weights 44 are specifically selected to emphasize features of interest. Different sets of weights 44 may be provided to emphasize or highlight different features of interest. This may be done using the technique of spectral unmixing. Spectral unmixing is described, for example, in Keshava, A survey of Spectral Unmixing Algorithms, Lincoln Laboratory Journal, Vol. 14, No. 1, 2003 pp. 55-78, which is hereby incorporated herein by reference. In some embodiments,

For example, different sets of weights 44 may be provided for creating images 43 useful on their own and/or when combined into composite images 47 for:

detection of pre-invasive lesions;

detection of infection;

detection of a specific collagen type;

vascular imaging;

detection of lesions in specific tissues;

etc.

The sets of weights may be derived based upon theoretical and/or empirically-determined characteristics of the fluorophores or other features of interest. The sets of weights may be optimized to reduce the number of images required to suitably highlight features of interest. For example, the sets of weights may be developed subject to a constraint limiting the use of negative weights. When such constraints are imposed the collection of negative-weight images can be reduced or eliminated.

FIGS. 5A and 5B are data flow diagrams that illustrate data flow in an example embodiment. In FIG. 5A, narrowband images 33 are obtained. Weights 44 may be obtained from the narrow band images 33 by one or more of PCA, spectral unmixing and expert classification followed by discriminant analysis. Other weights 44 may be determined by calculation. Weights 44 may be applied to combine images 33 to yield weighted sum images 43 which may, in turn, be combined to yield composite images 47.

As shown in FIG. 5B, weights 44 may also be used to control a light source to yield a spectrum in which wavelength bands have intensities specified by corresponding weights Wᵢ of a set of weights 44. Images of an area illuminated by the spectrum may be used as weighted sum images 43 and combined in suitable ways to yield composite images 47.

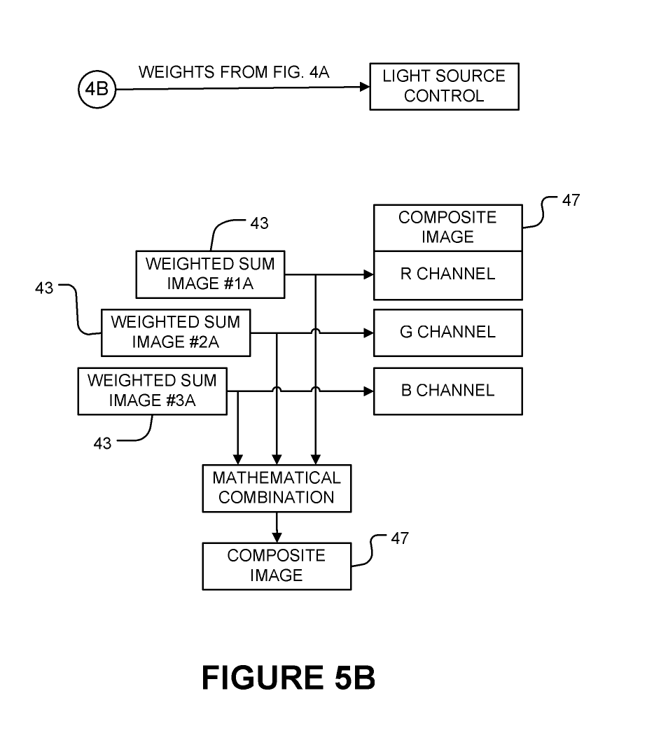

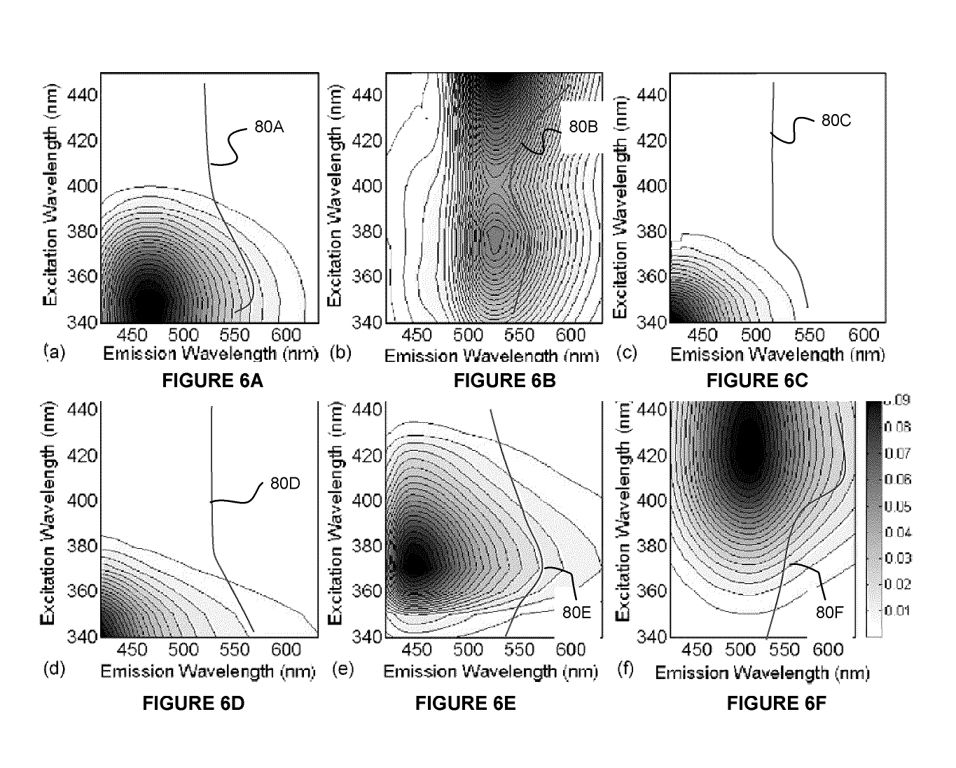

FIGS. 6A through 6F illustrate how the techniques described herein may be applied to distinguish different features of tissue. Each of these Figures shows an excitation emission matrix (EEM) for a different fluorophore. FIG. 6A illustrates an EEM for NADH. FIG. 6B illustrates an EEM for FAD. FIG. 6C illustrates an EEM for keratin. FIGS. 6C through 6E respectively illustrate EEMs for first, second and third components of stromal fluorescence. In FIGS. 6A through 6E, contour lines connect points of equal fluorescence intensity. Curves 80A through 80E show the efficiency as a function of wavelength with which excitation light of different wavelengths generates emission light of 530 nm. Curves 80A through 80E all have different shapes. This indicates that suitable choices of weights 44 may be used to distinguish between fluorescence emitted by the different fluorophores illustrated in FIGS. 5A through 5E. For example, images 43 may be obtained using suitable weights 44 for different excitation wavelengths and the resulting images 43 may be mathematically combined to provide an image that highlights one or more of the fluorophores or a desired relationship between the fluorophores.

In other embodiments, weights 44 are determined by applying a suitable discriminant analysis to a training set, as described above, for example.

In cases where the discriminant analysis (or other consideration) assigns negative weights to one or more wavelength bands, one image may be obtained in which the spectral composition of L_{IN} is according to the positive weights and a second image may be obtained in which the spectral composition of L_{IN} is according to the negative weights. The first and second image may then be subtracted.

The apparatus of FIG. 1 comprises a plurality of different sets 44A of weights 44. In some embodiments a user may switch between different ones of sets 44A on-the-fly through the use of any suitable user control. This facilitates apparatus like apparatus 10 being rapidly adjusted on the fly by an end user. For example, one setting (set of weights) may be available to detect pre-invasive lesions, another setting for emphasizing infection a third setting for specific collagen type detection, another for vascular imaging etc.

In some embodiments, apparatus 10 is configured to allow a user to select a desired set of weights 44 and to cause light source 12 to illuminate tissue T with a spectrum in which different wavelength bands contribute to an exposure taken by imaging detector 16 in relative amounts corresponding to the selected weights 44.

Weighted sum images 43 may be further processed, for example, in ways as described above.

It is preferable but not mandatory that light source 12 provide illumination at all wavelength bands simultaneously to obtain a single exposure weighted sum image 43. In the alternative one could control light source 12 to rapidly switch between different wavelength bands while imaging with imaging detector 16. Also, while it is preferable to control the relative exposures afforded to different wavelength bands by controlling the intensity of light emitted in those wavelength bands it is also or in the alternative possible to control the weighting by controlling the proportion of an exposure during which light source 12 illuminates tissue T with light in different wavelength bands.

Some embodiments apply images acquired as described herein in combination with a reflectance image associated with one or more specific excitation wavelengths (or weighted combination of wavelengths). In such embodiments the reflectance image may be applied to adjust/normalize on a location-by-location fashion (pixel by pixel or cluster of pixels by cluster of pixels) the images detected by imaging detector 16 prior to or during the generation of pseudo images (such as weighted sum images 43 or composite images 47) in which specific selected components/fluorophors/tissue types are highlighted. Such normalization may assist in further emphasizing features of interest in comparison to features visible in the reflection image.

In some embodiments, imaging detector 16 comprises a reflection imaging detector for obtaining the reflection image. The reflection imaging detector is sensitive to one or more wavelengths in L_{IN}. Imaging detector 16 may also comprise a fluorescence imaging detector that is not sensitive to wavelengths in L_{IN}. The fluorescence imaging detector may, for example, comprise a filter that blocks the wavelengths in L_{IN}.

In the alternative, imaging detector 16 may comprise one imaging detector that can be switched between a reflectance imaging mode in which it is sensitive to wavelengths in L_{IN} and a fluorescence imaging mode in which it is not sensitive to wavelengths in L_{IN} but is sensitive to wavelengths in another wavelength band of interest. In this alternative embodiment, imaging detector 16 can obtain reflectance and fluorescence images in rapid succession by obtaining one of the images and then switching modes before obtaining the other image. Switching modes may comprise switching filters in an optical path, electronically changing a wavelength band of the imaging detector or other approaches known in the art of imaging detectors.

Methods and apparatus as described herein may be applied in a range of contexts. For example, methods and apparatus may be applied in:

microscopy;

endoscopy;

bronchoscopy;

labroscopy.

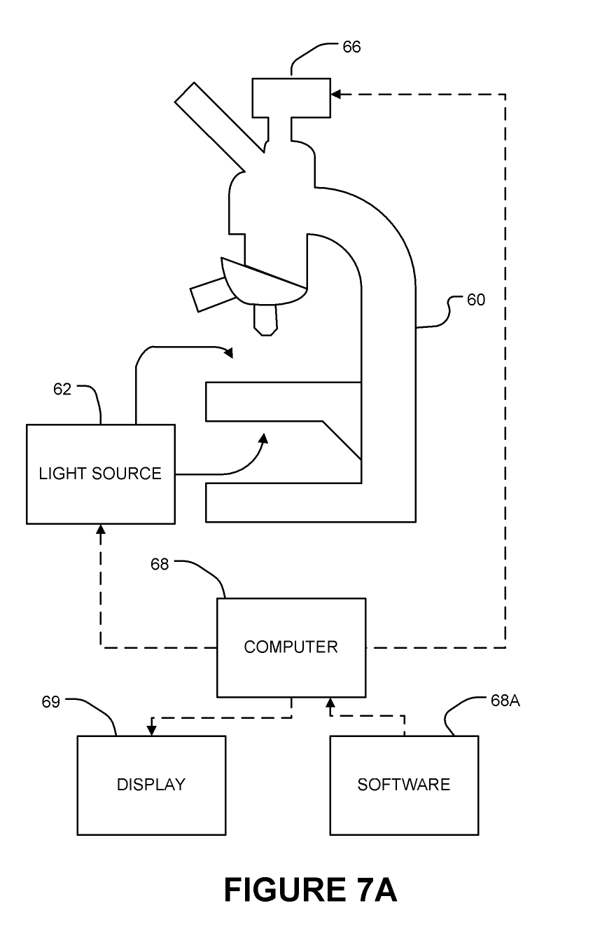

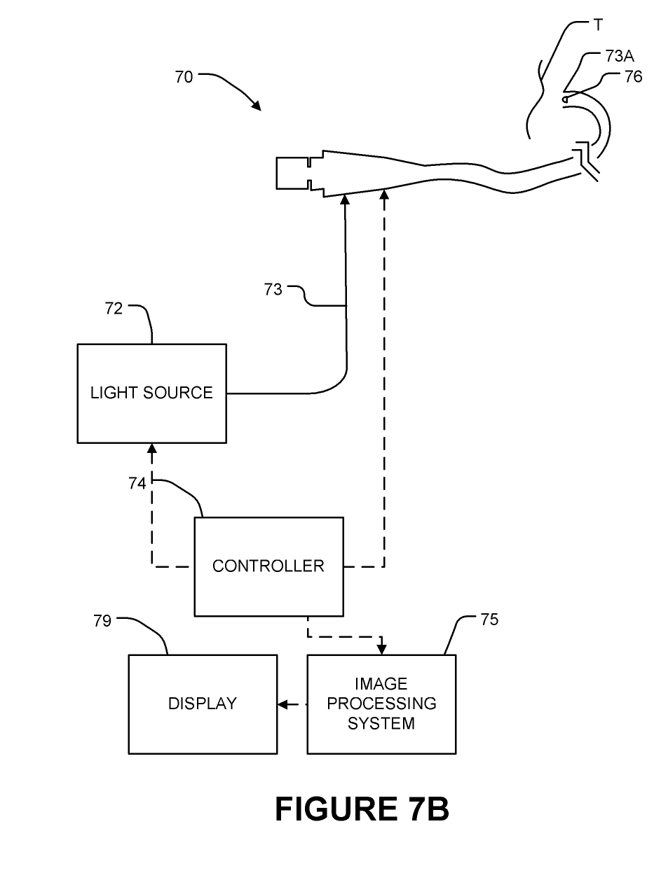

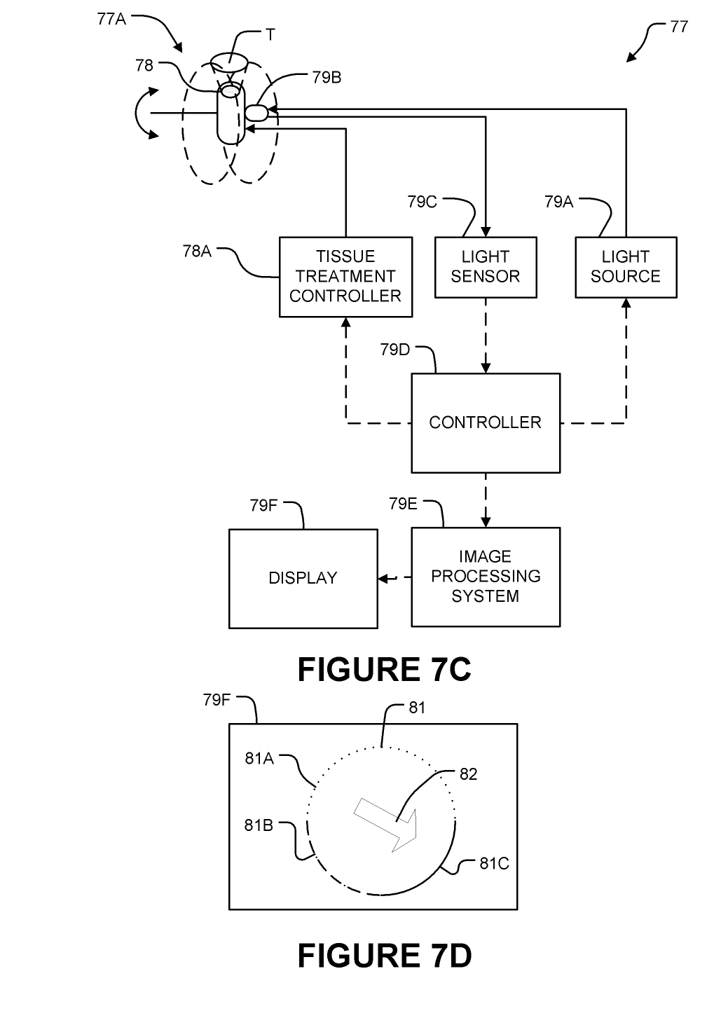

FIG. 7A shows an example microscopy application wherein a microscope 60 is equipped with a computer-controlled wavelength-selective light source 62 that illuminates a tissue sample TS either in transmission or reflection. Microscope 60 comprises an imaging detector 66 which may, for example, comprise a microscope camera. A computer 68 is connected to control light source 62 and imaging detector 66 by way of suitable interfaces (not shown) and to receive images from imaging detector 66. Computer 68 executes software 68A that provides a control system as described above and an image analysis system as described above. Images produced by computer 68 are displayed on a display 69. An example application of microscope 60 is multi-label fluorescence microscopy. Microscope 60 may, for example, comprise a laboratory microscope or a surgical microscope.

Microscope 60 may comprise a commercially available fluorescence microscope, for example. An example embodiment of the invention comprises a kit for adapting a fluorescence microscope to perform methods as described herein. The kit may comprise, for example, a light source 62 and computer software 68A.

FIG. 7B shows an endoscope system 70 according to an example embodiment. Endoscope system 70 comprises a computer-controlled wavelength-selective light source 72 that delivers light into a light guide 73. The light is emitted at a distal end 73A of light guide 73 to illuminate tissue T. Light from tissue T is detected by an imaging detector 76 that is mounted proximate to distal end 73A of light guide 73. Imaging detector 76 may, for example, comprise a CCD, CMOS, APS or other imaging chip. A controller 74 is connected to coordinate the operation of light source 72 and imaging detector 76 to obtain weighted sum images. Controller 74 comprises an image processing system 75. Image processing system 75 is configurable to processes the weighted sum images and/or display weighted sum images or composite images derived from the weighted sum images on a display 79. Image processing system 75 and controller 74 may be integrated or image processing system 75 may be separate from other aspects of controller 74.

FIG. 7C shows an example treatment system 77 in which tissues are subjected to a treatment. The treatment may comprise, for example, a thermal treatment, a treatment involving delivery of electromagnetic radiation (which could, for example, comprise infrared radiation or gamma radiation) or some other treatment that affects the properties of treated tissues. In the illustrated embodiment the treatment comprises locally heating tissues and is performed on tissues in and/or adjacent to walls of a vessel such as a blood vessel, a vessel within the heart or the like. Heating may be provided by any suitable means including infrared heating, thermal contact with a heater, application of ultrasound or the like.

Treatment system 77 comprises a treatment head 77A comprising a treatment source 78 configured to apply treatment to adjacent tissues under control of a tissue treatment controller 78A. Treatment head 77A may be rotated and moved along inside a vessel to treat tissues T on walls of the vessel. An imaging system comprising a light source 79A a rotating light collector 79B and a light sensor 79C images tissues on a wall of the vessel. In this embodiments, light sensor 79C may comprise a single light sensor or row of light sensors that builds up a linear image by acquiring light values for different rotations of light collector 79B. Light collector 79B may comprise a rotating mirror, for example. Light sensor 79C may be located on treatment head 77A or connected to head 77A by a suitable light guide. Light sensor 79C may comprise a filter to block light in the wavelength window of the spectrum emitted by light source 79A. Light sensor 79C may detect fluorescence in tissue T that has been excited by light from light source 79A. A controller 79D comprises an image processing system 79E that displays an image on a display 79F.

Light source 79A is controlled to emit light having a spectrum optimized for distinguishing treated areas of tissue T from untreated areas of tissue T. The spectrum may comprise, for example, a plurality of wavelength bands having intensities specified by weights previously established by a discriminant analysis or other feature selection method as described above. The weights may be stored in a memory or device accessible to or incorporated in controller 79D, which is connected to control light source 79A to issue light having the selected spectrum.

In some embodiments, controller 79D controls light source 79A to emit light having different spectra (specified by different sets of weights) at different times and image processing system 79E is configured to generate an image based on differences between light detected from the same part of tissue T when illuminated by different spectra.

FIG. 7D shows an example display which includes indicia 81 representing a wall of a vessel in which treatment head 77A is located. An attribute of indicia 81 (e.g. density, color, pattern or the like indicates the degree to which corresponding tissue has been treated. In the illustrated embodiment, a first section 81A indicates little or no response to treatment, a second section 81B indicates a moderate response to the treatment and a third section 81C indicates a higher response to the treatment. An indicia 82 indicates the current orientation of treatment source 78. A physician may monitor the progress of treatment with reference to display 79F and manipulate the rotation and position of treatment head 77 to provide a desired degree of treatment to a desired area of tissue T.

One example system and method comprises illuminating an area of interest with multiple excitation wavelengths. The multiple excitation wavelengths may have predetermined relative intensities and may be applied in sequence or simultaneously. In an example embodiment, the wavelengths include wavelengths in the range of 400 nm to 530 nm every 10 nm. The amount of light of each wavelength delivered to the area of interest is controlled to maintain a fixed relationship between amounts of light of each wavelength delivered. One or more emitted wavelength images are detected for each delivery of excitation illumination. For example, the detected images may detect light in the wavelength range of 550-700 nm. The different emitted wavelength images for the different excitation wavelengths are combined into a single representation. For example, a single representation may be produced from the emitted wavelength images using principle component decomposition. A false color composite image may be prepared in which three presented colors are the three first principle components.

In some embodiments, images from different weighted-excitation generated images are mathematically combined to select for specific features such as objects, areas, tissue types, tissue components, and/or other features of interest in the area. The mathematical combination may be chosen, for example, to select for neoplastic tissue, or collagen type or NADH or FAD or blood absorption/vascular structures, etc. The mathematical combination may be chosen to achieve spectral unmixing of excitation-based images.

Some embodiments provide systems and methods for in vivo fluorescence imaging for application to identify diseased tissues, tissues that have been subjected to a treatment, or pathological conditions such as cancer or premalignant neoplasia. The skin, oral cavity, lung, cervix, GI Tract and other sites may be imaged.

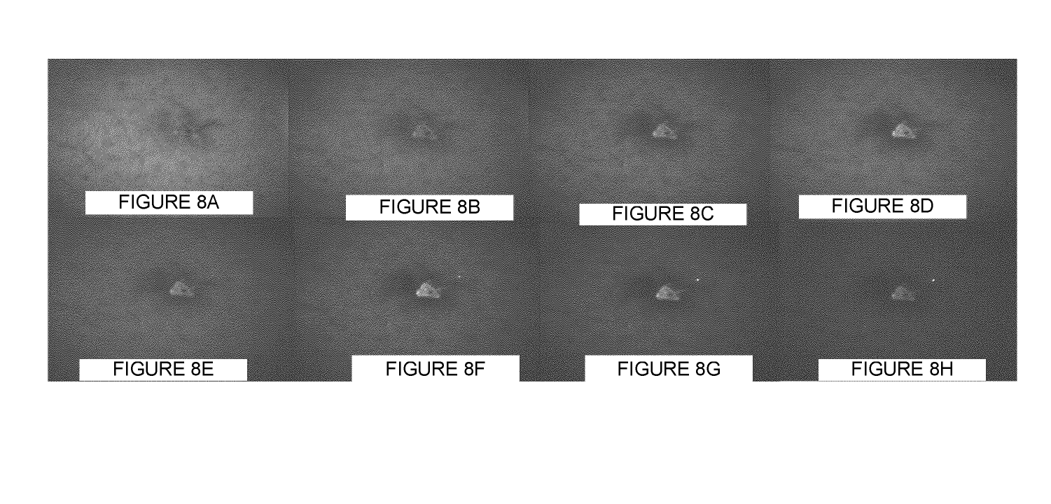

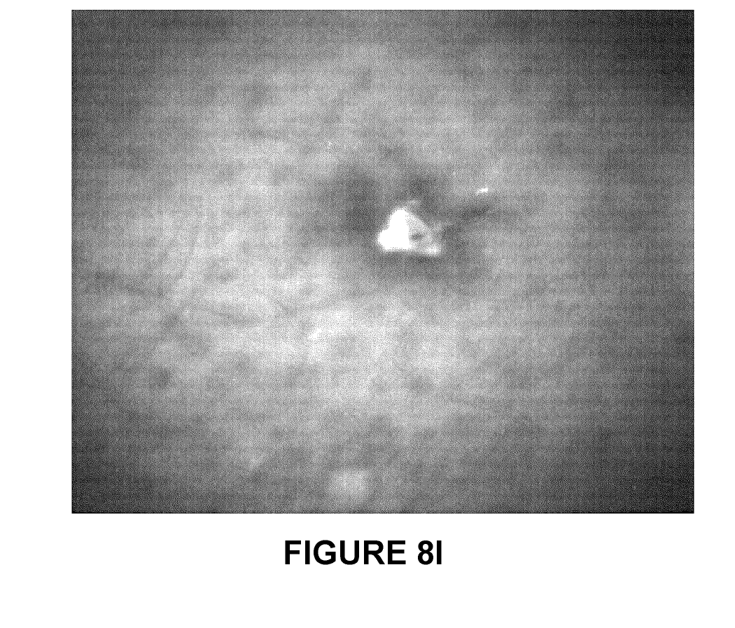

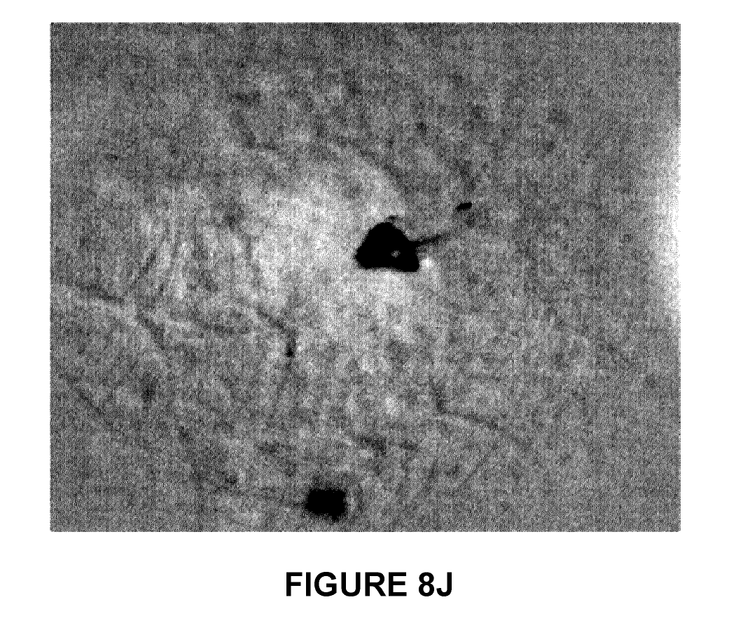

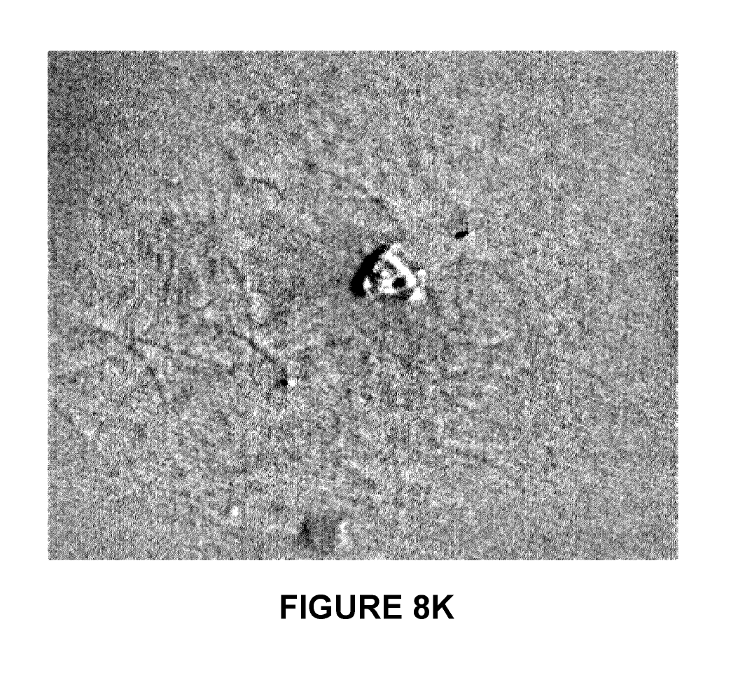

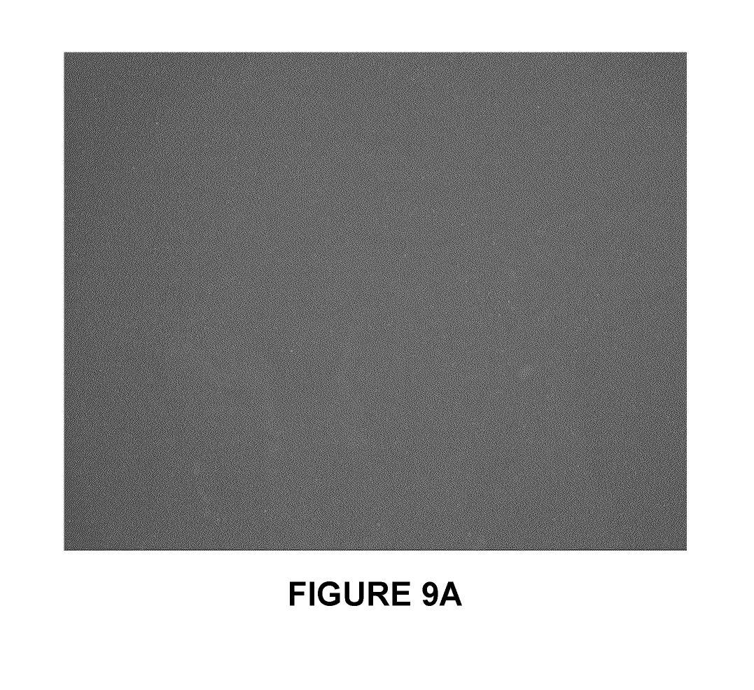

FIGS. 8A through 8K illustrate the application of the methods described above in vivo. FIGS. 8A through 8H are respectively images of tissue in the wavelength range of 580 nm to 650 nm for excitation at 410 nm, 430 nm, 450 nm, 470 nm, 490 nm, 510 nm, 530 nm and 550 nm. The bandwidth of each excitation band was 20 nm. Principal component analysis was used to generate component images which were scaled for display. FIG. 81 shows the first component. FIG. 8J shows the second component and FIG. 8K shows the third component. The component images were combined to provide a color composite image (not shown).

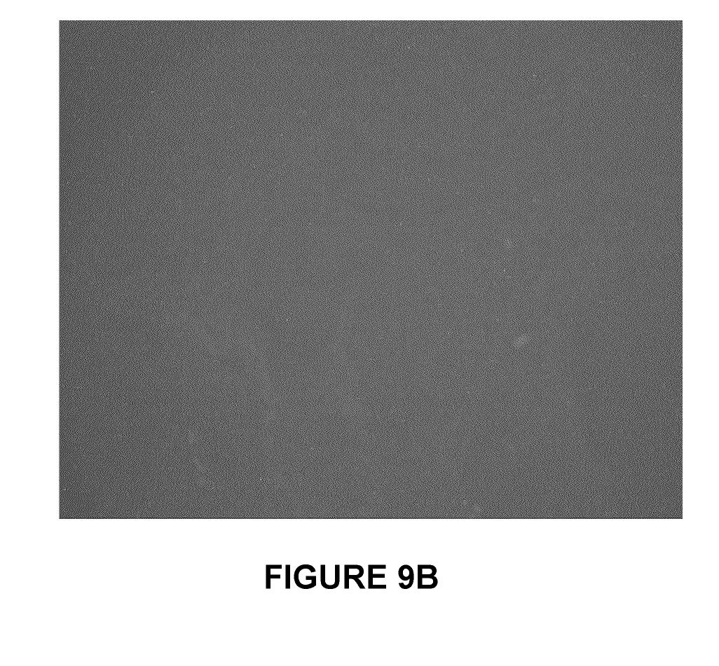

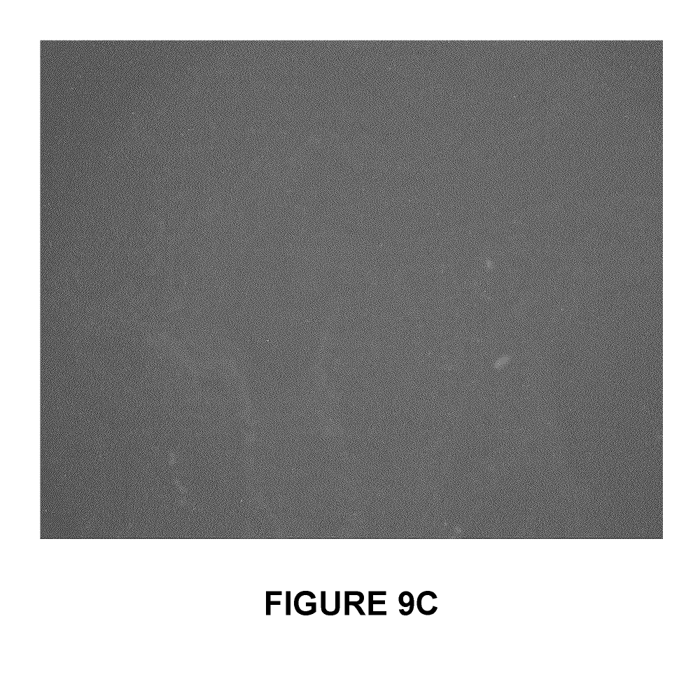

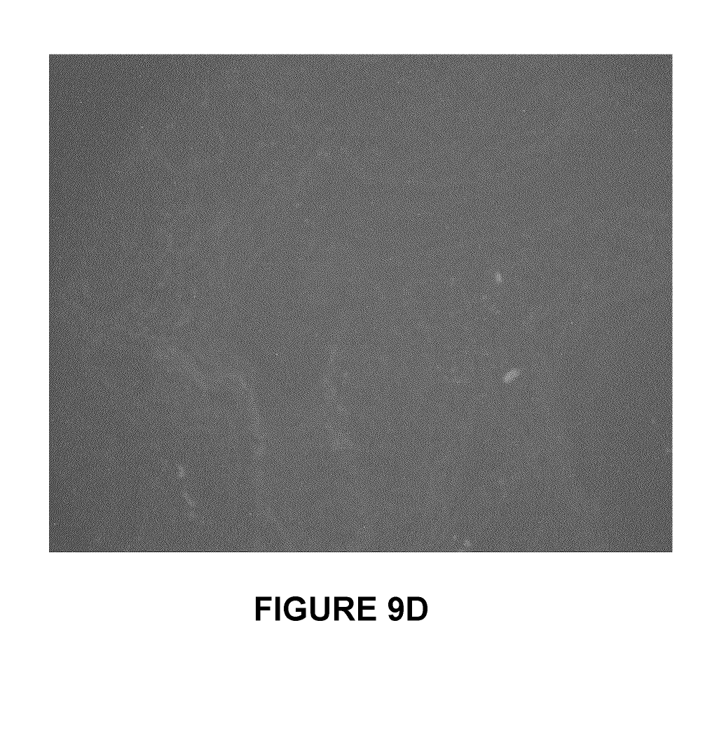

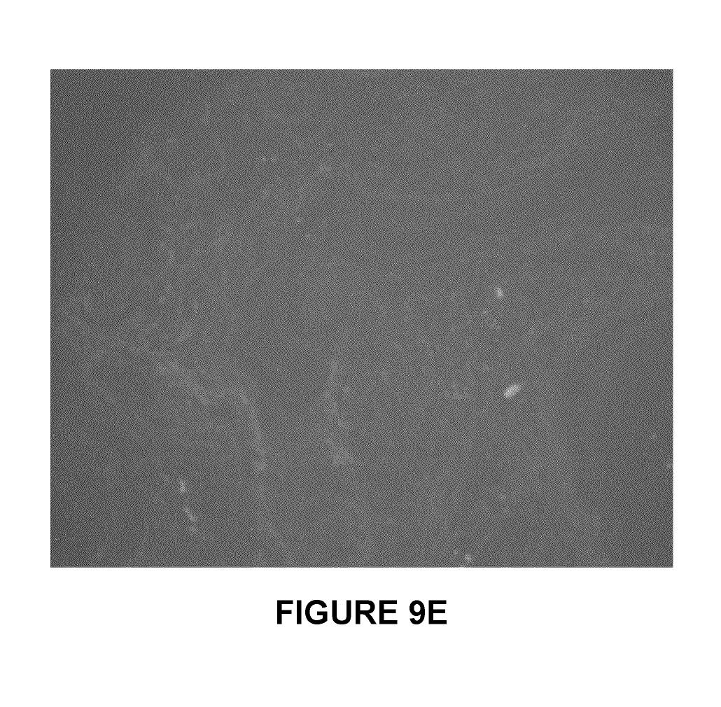

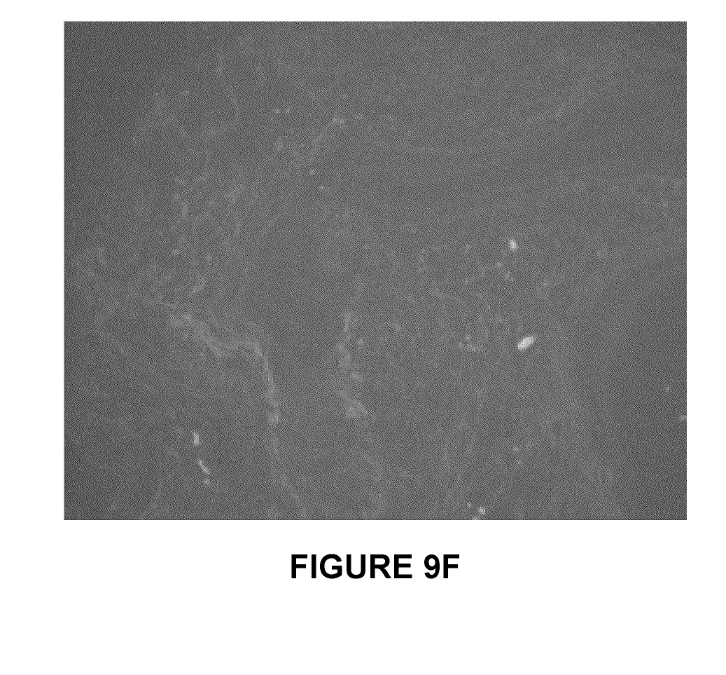

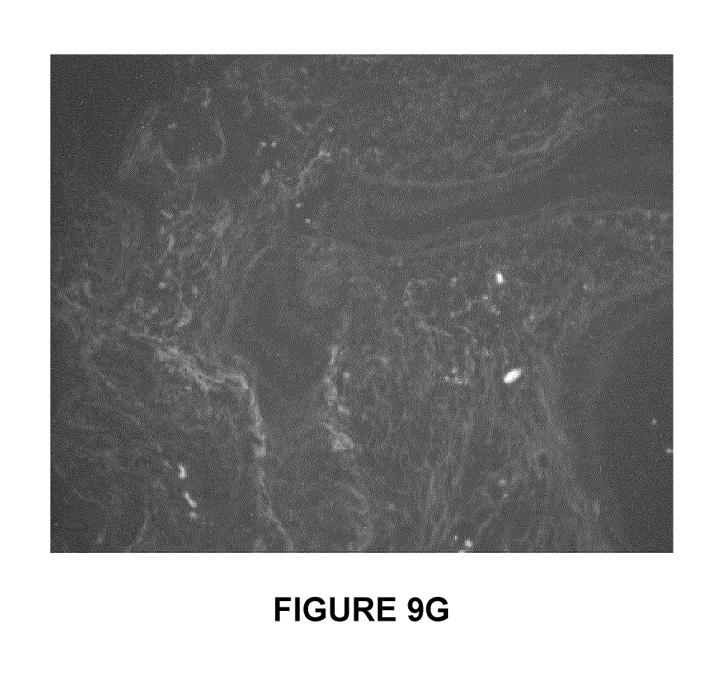

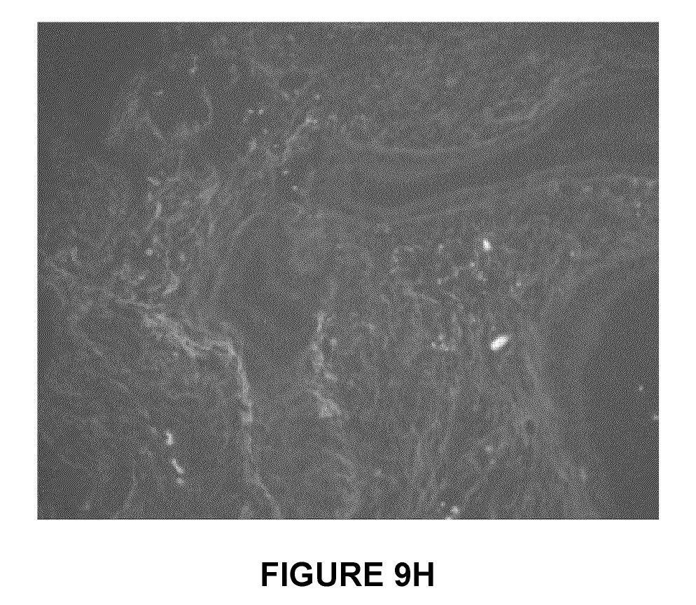

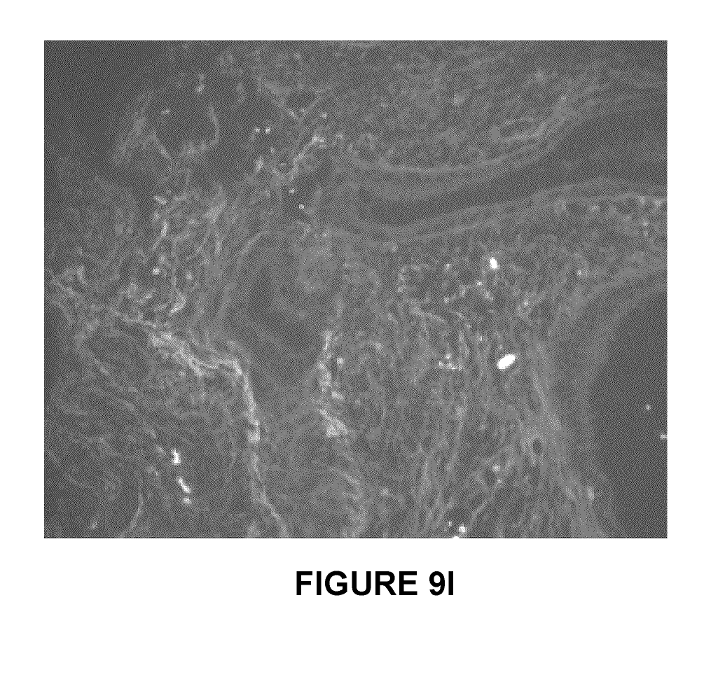

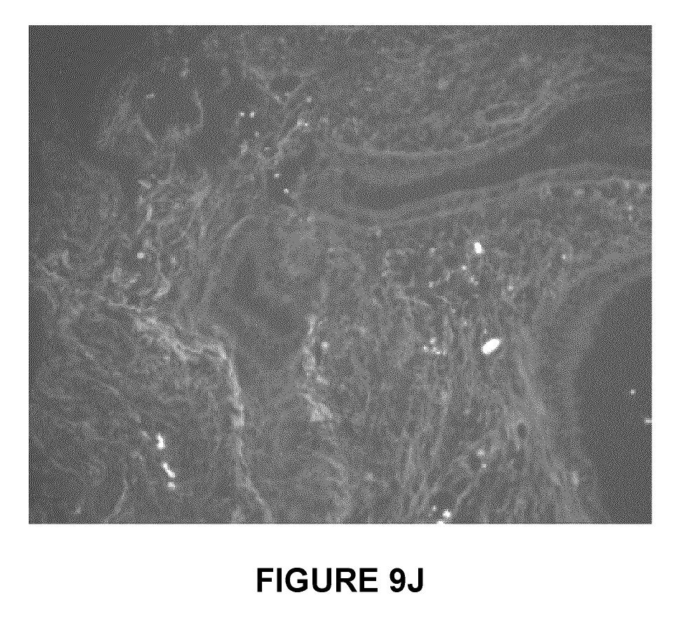

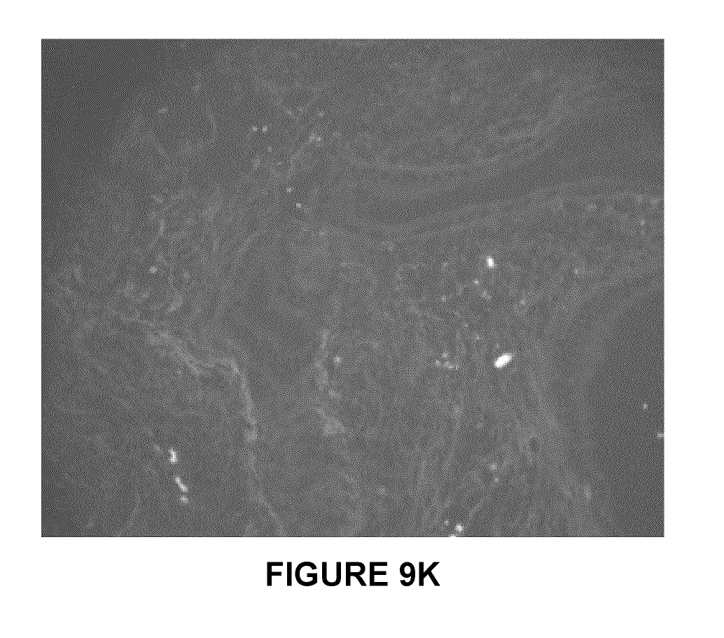

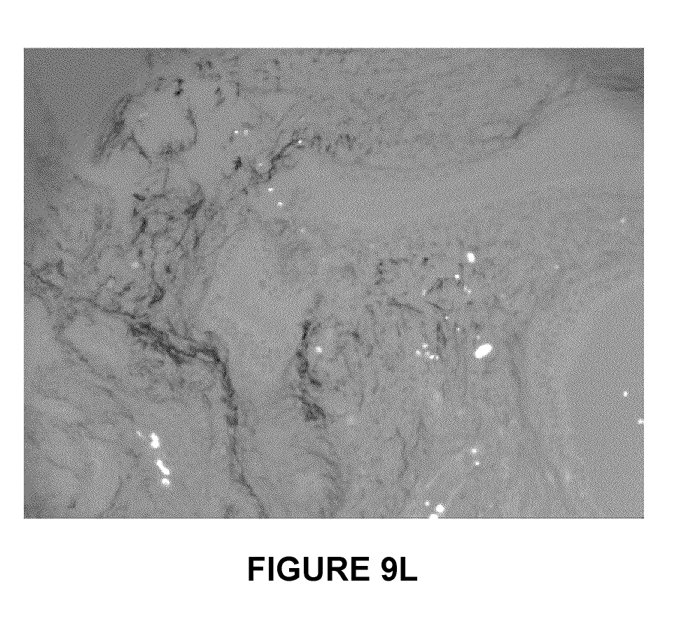

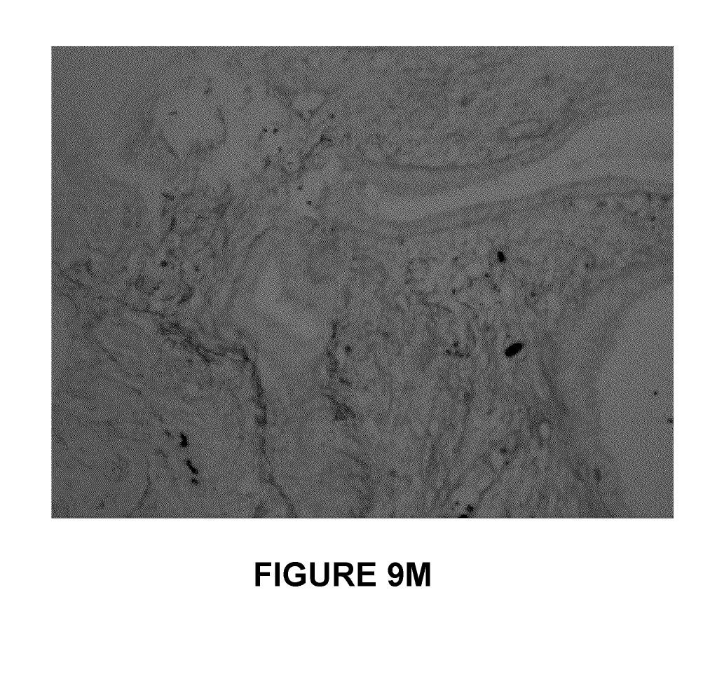

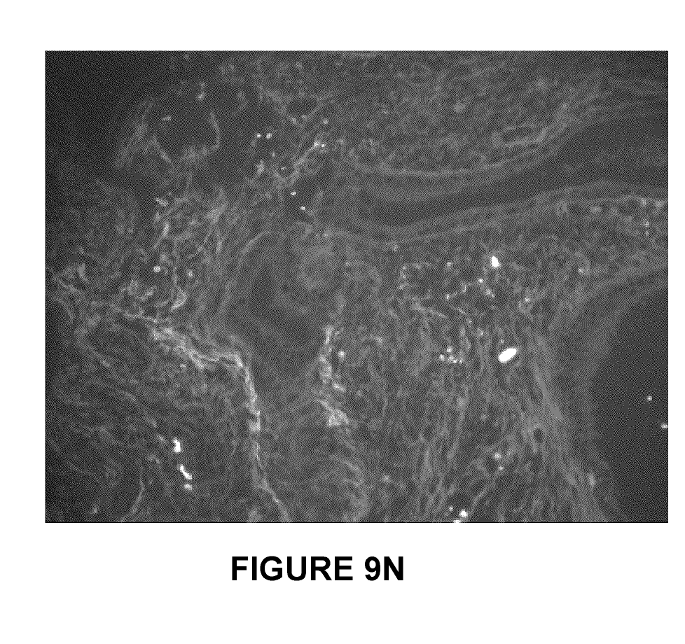

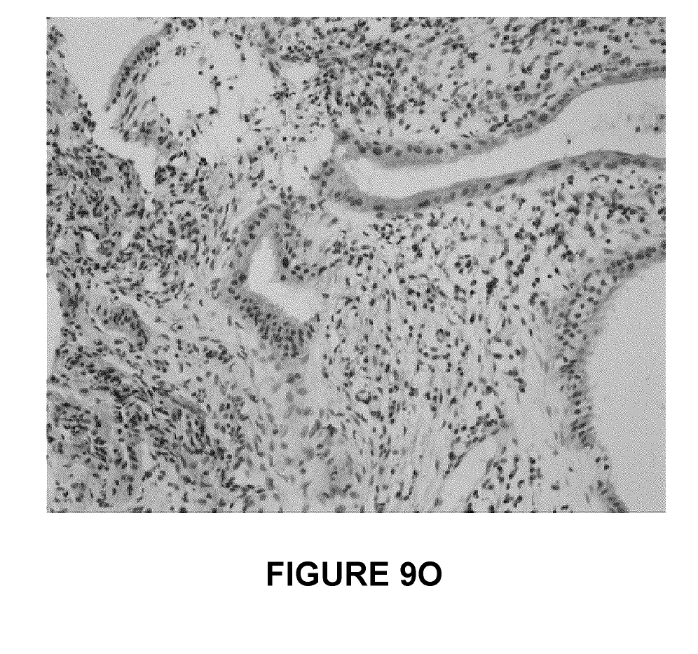

FIGS. 9A through 9O illustrate the application of the methods described above ex vivo in microscopy. FIGS. 9A through 9K are respectively images of tissue in the wavelength range of 580 nm to 650 nm for excitation at 420 nm, 430 nm, 440 nm, 450 nm, 460 nm, 470 nm, 480 nm, 490 nm, 500 nm, 510 nm, and 520 nm. The tissue was stained with hematoxylin. The bandwidth of each excitation band was 20 nm. Principal component analysis was used to generate component images which were scaled for display. FIG. 9L shows the first component. FIG. 9M shows the second component and FIG. 9N shows the third component. It can be seen that different tissue features are highlighted in FIGS. 9L, 9M and 9N. The component images were combined to provide a color composite image (not shown). FIG. 9O is a transmission (absorption) image of the same tissue.

Some embodiments provide apparatus and methods useful for imaging based at least in part on photo-bleaching. In some embodiments photo-bleaching is determined by illuminating an area of interest and acquiring at least two images of the illuminated area of interest. The at least two images may detect fluorescence from the area if interest. The illumination may be present throughout the acquisition of the two or more images or may be off between acquisition of the images.

Photo-bleaching involves a reduction in autofluorescence as a result of exposure to light. Photo bleaching may be measured by comparing the amount of autofluorescence in images taken after tissue has received different amounts of light exposure. Where tissue receives light exposure during each image the images may be acquired immediately one after the other, if desired.

In some embodiments, contributions to photo bleaching are determined for different wavelength bands of light L_{IN}.

In an example embodiment performed using the apparatus illustrated in FIG. 1, light source 12 is controlled to emit light in narrow bands and imaging detector 16 is operated to obtain a plurality of images for each of the narrow bands. Each of the plurality of images is obtained while light source 12 is illuminating the area of interest with light of the corresponding wavelength band.

In some embodiments, the plurality of images are acquired for one band before the plurality of images is acquired for a next band. For example, where wavelength bands 1 to N are of interest and M images (where M≧2) are acquired for each band then controller 20 may control light source 12 and imaging detector 16 to obtain a sequence of M images for band #1 followed by a sequence of M images for band #2 etc.

In other embodiments controller 20 may control light source 12 and imaging detector 16 so that the acquisition of images for different wavelength bands is interleaved. For example, controller 20 may control light source 12 and imaging detector 16 to obtain a first image in sequence for each of bands 1 to N followed by a second image in sequence for each of bands 1 to N and so on.

A measure of photo-bleaching may be obtained by subtracting the acquired images from one another. For example, the second through Mth images corresponding to an illumination wavelength band may be subtracted from the first image corresponding to the illumination wavelength band.

In some embodiments, difference images are combined to yield composite images representing a spatial variation in Photo bleaching. The combination may comprise a weighted combination in which different weights are allocated to difference images corresponding to different wavelength bands, for example.

In some embodiments what is of interest is how photo-bleaching varies from location to location in an area of interest as opposed to the exact amount of photo-bleaching measured at a particular location. In such embodiments the difference images may be normalized.

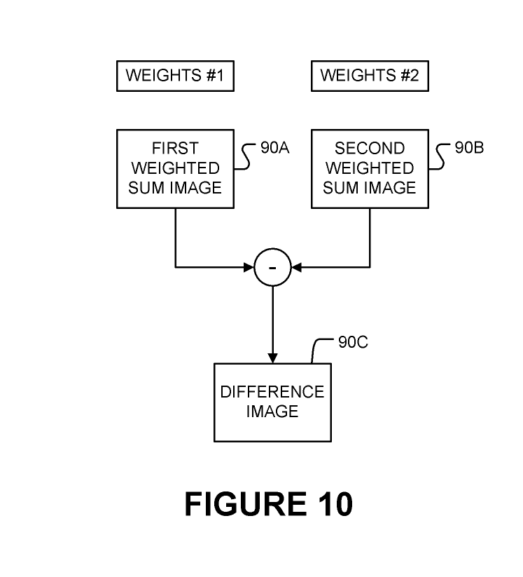

FIG. 10 illustrates data flow in another example embodiment. In this embodiment light source 12 is controlled to emit light having a spectrum determined by a first set of weights and a first weighted sum image 90A is acquired. Light source 12 is subsequently controlled to emit light having a spectrum determined by a second set of weights and a second weighted sum image 90B is acquired. In some embodiments the second weighted sum image is acquired immediately after the first weighted sum image is acquired. In some embodiments, a time period is provided between acquiring the first and second weighted sum images, In such embodiments, light source 12 may optionally be controlled to emit light of a third spectrum defined by a third set of weights during the time period. The first, second and third spectra may be the same or different from one another.

First and second weighted sum images 90A and 90B are subtracted to yield a difference image 90C. The first and second sets of weights may be selected to highlight differences in photo-bleaching times between different locations in the imaged area. The first and second sets of weights may be established, for example, by obtaining two or more images of a reference tissue illuminated by light in each of a plurality of individual narrow wavelength bands. The resulting reference images are mathematically analyzed to establish reference weights such that, when the reference images are combined according to the reference weights, the resulting image highlights differences in photo-bleaching times from location-to location in the reference tissue. Weights for the light used to illuminate tissues to acquire the first and second weighted sum images may be derived from the reference weights.

In any of the embodiments described herein, tissue to be examined may be labeled, for example, by means of one or more suitable stains. An advantage of some embodiments is that multiple distinct labels may be detected without the need to obtain multiple images using multiple different filters. In addition methods and apparatus as described herein permit different labels to be distinguished based at least in part upon their absorption spectra. This can permit a larger number of labels to be distinguished than would otherwise be feasible.

Methods as described herein are not limited to any specific tissue types. The methods may be applied to a wide range of tissues including:

tissues of the mouth;

lung tissue;

cervical tissue;

gastrointestinal tissue;

skin;

etc.

Applications of the methods and apparatus described herein include tissue screening, biopsy guidance, automated segmentation of images, microscopy, endoscopy, and the like. The methods and apparatus described herein may also be applied in forensics, process control, and other industrial purposes.

From the above, it can be appreciated that the invention may be implemented in a wide range of ways.

Certain implementations of the invention comprise computer processors which execute software instructions which cause the processors to perform a method of the invention. For example, one or more processors in an imaging system may implement the methods of FIGS. 2 and/or 4 by executing software instructions in a program memory accessible to the processors. The invention may also be provided in the form of a program product. The program product may comprise any medium which carries a set of computer-readable signals comprising instructions which, when executed by a data processor, cause the data processor to execute a method of the invention. Program products according to the invention may be in any of a wide variety of forms. The program product may comprise, for example, physical media such as magnetic data storage media including floppy diskettes, hard disk drives, optical data storage media including CD ROMs, DVDs, electronic data storage media including ROMs, flash RAM, or the like. The computer-readable signals on the program product may optionally be compressed or encrypted.

Where a component (e.g. a software module, processor, assembly, device, circuit, etc.) is referred to above, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

1. A tissue imaging method comprising:
obtaining a plurality of images by performing at least two iterations of:
providing a set of weights containing a weight for each of a plurality of spectral bands and controlling a computer-controlled color-selectable light source to illuminate a tissue with light in a first wavelength window, the light having a spectral composition according to the weights; and
operating an imaging detector to obtain at least one image of the tissue in one or more second wavelength windows outside of the first wavelength window and including the at least one image in the plurality of images;
combining the plurality of images into a composite image; and,
displaying the composite image;
wherein the set of weights is different in different iterations.

2. A method according to claim 1 wherein, in each of the iterations, the weights of the set of weights are weights corresponding to a principal component.

3. A method according to claim 2 wherein the plurality of images consist of N images corresponding respectively to the highest-ranked N principal components produced by a principal component analysis of images produced by illumination at a plurality of wavelength bands within the first wavelength window.

4. A method according to claim 1 wherein, in each of the iterations, the weights of the set of weights correspond to the abundances of endmembers determined by a spectral unmixing algorithm.

5. A method according to claim 1 wherein, in each of the iterations, the weights of the set of weights correspond to coefficients of a discriminant analysis.

6. A method according to claim 1 comprising, in response to a user input changing the sets of weights to different sets of weights and then repeating the method.

7. A method according to claim 1 further comprising, obtaining a reflection image of the tissue at one or more wavelengths within the first wavelength window and normalizing the plurality of images based on the reflection image.

8. A method according to claim 1 wherein the set of weights for at least one iteration comprises one or more positive weights and one or more negative weights and the method comprises:
obtaining a first image by controlling the computer-controlled color-selectable light source to illuminate the tissue with light having a first spectral composition according to the positive weights and operating the imaging detector to acquire the first image;
obtaining a second image by controlling the computer-controlled color-selectable light source to illuminate the tissue with light having a second spectral composition according to the negative weights and operating the imaging detector to acquire the second image; and,
prior to or during combining the plurality of images, subtractively combining the first and second images.

9. A method according to claim 1 wherein the second wavelength window comprises longer wavelengths than the first wavelength window.

10. A method according to claim 8 wherein the first wavelength window is in the visible spectrum.

11. A method according to claim 9 wherein the first wavelength window comprises wavelengths in the range of 400 to 500 nm and the second wavelength window comprises wavelengths in excess of 550 nm.

12. A method according to claim 11 wherein the second wavelength window comprises the wavelength range of 580 nm to 650 nm.

13. A method according to claim 12 wherein the composite image comprises a false color image and combining the plurality of images comprises assigning each of the images of the plurality of images to a corresponding color coordinate of the composite image.

14. A method according to claim 1 comprising automatically segmenting one or more of the plurality of images and the composite image.

15. An imaging method comprising:
obtaining a set of narrow band images of a reference tissue each narrow band image corresponding to an illumination wavelength band;
based on the narrow band images, determining a set of weights selected to emphasize features of interest in an image combining some or all of the narrow band images according to the weights;
controlling a light source to illuminate a tissue of interest with light having a spectrum defined by the set of weights; and,
acquiring an image of the illuminated tissue of interest.

16. A method according to claim 15 comprising determining the weights by principal component analysis of the narrow band images.

17. A method according to claim 16 wherein the weights correspond to a principal component of the narrow-band images.

18. A method according to claim 15 wherein determining the set of weights comprises performing a spectral unmixing algorithm.

19. A method according to claim 15 wherein determining the weights comprises performing a discriminant analysis on the narrow band images.

20. A method according to claim 15 wherein acquiring the image comprises excluding from the image light from a first wavelength window containing the spectrum.

21. A method according to claim 20 wherein the first wavelength window is in the visible spectrum.

22. A method according to claim 21 wherein the first wavelength window comprises wavelengths in the range of 400 to 500 nm and acquiring the image comprises imaging in a second wavelength window comprising wavelengths in excess of 550 nm.

23. A method according to claim 22 wherein the second wavelength window comprises the wavelength range of 580 nm to 650 nm.

24. A method according to claim 15 comprising acquiring a reflectance image of the illuminated tissue of interest and normalizing the image of the illuminated tissue of interest based on the reflectance image.

25. A method according to claim 24 comprising normalizing the image of the illuminated tissue of interest on a pixel-by-pixel basis.

26. A method according to claim 15 comprising acquiring an additional image of the illuminated tissue of interest and subtracting the image of the illuminated tissue of interest and the an additional image of the illuminated tissue of interest to yield an image reflecting local differences in photo-bleaching.

27. A method according to claim 26 wherein acquiring the additional image comprises controlling the light source to illuminate the tissue of interest with light having a second spectrum defined by a second set of weights.

28. A method for imaging, the method comprising:
for each of a plurality of wavelength bands determining a corresponding weight, the weights selected to emphasize features of interest in a weighted sum image resulting from a weighted sum of a plurality of narrow band images of an area of interest;
controlling a computer-controlled color-selective light source to illuminate the area of interest with light having a spectrum defined by the weights;
acquiring an image of the illuminated area of interest.

29. A method according to claim 28 wherein the image is a fluorescence image.

30. A method according to claim 28 wherein the spectrum lies within a first wavelength window and the image is an optical image of light in a second wavelength window outside of the first wavelength window.

31. A method according to claim 30 wherein the first wavelength window is in the visible spectrum.

32. A method according to claim 30 wherein the second wavelength window is at longer wavelengths than the first wavelength window.

33. A method according to claim 28 wherein the weights are selected for one or more of:
emphasizing differences in concentrations of one or more of collagen and elastinen;
emphasizing contrast between areas having different amounts of vascularity;
emphasizing contrast between areas having different relative amounts of collagen and elastinen; and
emphasizing contrast between different tissue types or cell types.

34. (canceled)

35. (canceled)

36. (canceled)

37. Imaging apparatus comprising:
a computer-controlled color-selective light source;
an imaging detector located to image an area being illuminated by the computer-controlled light source;
a display; and
a controller comprising a plurality of predetermined sets of weights, each set of weights comprising a weight for each of a plurality of spectral bands, the controller configured to control the light source and the imaging detector to obtain a plurality of images by performing at least two iterations of:
providing one of the sets of weights to the light source and controlling the light source to illuminate the area with light in a first wavelength window, the light having a spectral composition according to the weights;
operating the imaging detector to obtain at least one image of the area in one or more second wavelength windows outside of the first wavelength window; and,
including the at least one image in the plurality of images; and
combining the plurality of images into a composite image; and,
displaying the composite image on the display.

38. Imaging apparatus comprising:
a computer-controlled color-selective light source;
an imaging detector located to image an area being illuminated by the computer-controlled light source;
a display;
a controller comprising a plurality of predetermined sets of weights, each set of weights comprising a weight for each of a plurality of spectral bands;
a user interface operable to receive user input for selecting one of the predetermined sets of weights; wherein the controller is configured to control the light source and the imaging detector to obtain one or more images by:
providing one of the sets of weights to the light source and controlling the light source to illuminate the area with light in a first wavelength window, the light having a spectral composition according to the weights; and
operating the imaging detector to obtain at least one image of the area in one or more second wavelength windows outside of the first wavelength window; and
displaying the image on the display.

39. Imaging apparatus according to claim 38 wherein each of the sets of weights is selected to emphasize a different particular type of feature in the images.

40. Imaging apparatus according to claim 38 wherein the sets of weights comprise at least one set of weights corresponding to a principal component image.

41. Imaging apparatus according to claim 38 wherein the sets of weights comprise at least one set of weights corresponding to spectral unmixing abundances.

42. Imaging apparatus according to claim 38 wherein the sets of weights comprise at least one set of weights corresponding to coefficients of a discriminant analysis.

43. Imaging apparatus according to claim 38 wherein the sets of weights comprise at least one set of weights calculated to selectively cause emission of light by one or more selected fluorophores.

44. Imaging apparatus according to claim 38 comprising an image analysis system configured to segment the image.

45. (canceled)

46. (canceled)
